(19) United States
(12) Patent Application Publication
(10) Pub. No.: US 2024/0093950 A1
(43) Pub. Date: Mar. 21, 2024

(54) GREEN ENERGY THERMAL STORAGE SYSTEM

(71) Applicant: HOLTEC INTERNATIONAL, Camden, NJ (US)

(72) Inventor: Krishna P. SINGH, Jupiter, FL (US)

(73) Assignee: HOLTEC INTERNATIONAL, Camden, NJ (US)

(21) Appl. No.: 18/239,949

(22) Filed: Aug. 30, 2023

Related U.S. Application Data
(60) Provisional application No. 63/386,200, filed on Dec. 6, 2022.
(60) Provisional application No. 63/407,872, filed on Sep. 19, 2022.

(51) Int. Cl. F28D 20/02

(52) U.S. Cl. CPC F28D 20/021; F28D 2020/0013

(57) ABSTRACT

A green boiler includes a thermal energy storage vessel containing a captive bed of a thermal mass composition operable to store thermal energy, an array of heaters embedded in the mass, and at least one heat exchanger comprising a tube bundle. The heaters in one embodiment may be electric and coupled to an electric power source to heat the thermal mass. The tube bundle comprises tubes embedded in the thermal mass composition which are configured to convey heat transfer fluid (e.g., water or other) through a tube-side of the tubes. In operation, the heat transfer fluid is heated by absorbing stored thermal energy from the thermal mass composition. The thermal mass composition may be heated by power extracted from the power grid during off-peak demand periods in some embodiments. The vessel may produce heated water or steam for district heating, or steam for power generation or industrial uses.

### CROSS-REFERENCE TO RELATED APPLICATIONS

The present application claims the benefit of priority to U.S. Provisional Patent Application No. 63/386,200 filed Dec. 6, 2022, and U.S. Provisional Patent Application No. 63/407,872 filed Sep. 19, 2022; the entireties of which are incorporated herein by reference.

### FIELD OF THE INVENTION

The present invention relates to energy storage systems, and more particularly to such a system which utilizes a heat-absorbing thermal mass composition operable to store thermal or heat energy from electricity extracted from the electric power grid or other source of electric, and produces hot water for district heating or other purposes, or steam for industrial purposes or to generate electric power via the Rankine cycle during peak electric power grid load demand periods.

### BACKGROUND OF THE INVENTION

As the transformation of the traditional energy generation landscape to non-polluting “green” energy accelerates, tens of thousands of fossil-fired power plants (especially coal-fired plant) around the world are headed to premature shutdown and decommissioning. In fact, supported by an emerging consensus to decarbonize the economy, the process of decommissioning older fossil power plants has already begun in favor of more environmentally friendly non-polluting “green” alternatives for generating electric power. Green energy alternatives are needed as a substitute for fossil-fueled boilers in the traditional steam-to-electric Rankine power generation cycle shown in FIG. 1A.

Green energy alternative are also needed as substitute for fossil-fueled boilers used to produce hot water for regional district heating applications used in some municipalities and cities.

One outcome of the rise of green energy renewables is the increased oscillation (highs and lows) in power generation levels which calls for energy storage systems to levelize the power delivered to the electric power grid by such green generating systems.

### SUMMARY OF THE INVENTION

The present disclosure provides an environmentally friendly “green” thermal energy storage system which renders its stored thermal energy when desired to heat a working heat transfer fluid (e.g., working fluid) to produce a heated liquid and/or steam. The heat transfer fluid may be water in some embodiments and applications; however, other types of working heat transfer fluids may be used in certain other applications.

The present green thermal energy storage system generally comprises a “green” boiler including a heavily-insulated thermal energy storage (TES) vessel and one or more heat exchangers integrated into and forming an integral part of the vessel supported by a single housing. The heat exchangers each comprise a tube bundle directly embedded in a thermal mass composition inside the TES vessel and each may be a steam generator in some embodiments configured and operable to heat and convert a heat transfer fluid in liquid state (e.g., water) to steam. In other embodiments, the heat exchangers may be configured and operable to heat a heat transfer fluid to a working temperature and remains in a liquid state before and after heating in the vessel.

The TES vessel internally contains a “captive” bed of the thermal mass composition formulated and operable to absorb and store heat derived from at least one heater embedded therein that heats the thermal mass composition. The heater may be an electric heater coupled to an electric power source, and a plurality of heaters may be provided in certain embodiments to heat the thermal mass. In other possible embodiments, the heater or heaters may comprise secondary heat exchangers which convey a second heat transfer fluid through the bed of thermal mass composition on the internal tube-side of tube bundles for the purpose of heating the thermal mass. This is distinctive from the heat exchangers cited previously which circulate the working heat transfer fluid through the thermal mass bed which performs the work (e.g., power generation, district heating, or other). The term “captive” used above connotes that the thermal mass composition remains stationary and does not flow into or out of the vessel. Accordingly, the heat exchangers circulate the working heat transfer fluid inside tubes (tube-side) of the tube bundle through the thermal mass composition, which releases its stored thermal energy to be absorbed by the heat transfer fluid which becomes heated. By contrast, the bed of captive thermal mass composition contained in the TES vessel remains stationary and does not flow into or out of the vessel one embodiment.

The thermal mass composition in one non-limiting embodiment may comprise a mixture including a phase change material (PCM) in combination with one or more other metallic materials as further described herein; all of which have heat absorption properties operable to absorb and retain heat over a period of time. Both the PCM and materials of the mixture may be in the form of solid granular particles at ambient temperatures when not heated by the thermal mass composition. The PCM material preferably has a lower melting temperature than the metallic materials in one embodiment such that PCM material melts when heated by the electric heaters while the materials remain in a solid particle state. The thermal mass composition heats the heat transfer fluid on demand which flows inside tube bundles of one or more heat exchangers to produce steam for power generation or industrial uses, or alternatively hot water for district heating or industrial uses.

For any end use application of the present thermal energy storage system, electric power is preferably extracted from a source of electricity such as the electric power grid to heat the thermal mass composition in the vessel during off-peak load demand periods of the grid when energy prices are low. However, the thermal energy storage system may extract electric power from the power grid during other periods including peak load demand periods when necessary. Accordingly, the timing of when electric power is drawn from the power grid or other source for storage as thermal energy is not limited to any specific period of time and is a matter of economics and demand for heating or electricity.

A combined green thermal energy storage and Rankine power generation system according to the present disclosure provides the means to align its electric power output to electric generating scheme to the fluctuating load demand of the electric power grid. The system can be retrofit at existing fossil energy power generation sites or used in a new power generation site in conjunction with operating a traditional Rankine steam to electric power scheme which is well known in the art. The turbogenerator (i.e. steam turbine and electric generator set) and the associated remaining balance of plant Rankine cycle equipment infrastructure remains the same as shown in FIG. 1B.

The present green thermal energy system can derive its input energy from the electric power grid, or in other cases at least in part from a dedicated and associated solar, wind, or a nuclear plant at the same site as the green thermal energy storage vessel.

The present green thermal energy storage system concept relies on the fact that the electricity delivered to the electric power grid by generating plants during most periods of a 24-hour day exceeds the actual real-time consumer (i.e. industrial, commercial, or residential) demand for power. This means that there are windows of time when there is cheap surplus power available but unfortunately wasted. The present system will take the surplus energy from the grid, or alternatively directly from a co-located green energy plant (e.g., solar, wind, or nuclear), and thermally store the energy in the bed of thermal mass composition stored in the TES vessel.

In some embodiments, intermittent renewable energy sources such as solar and wind power may be used instead of or in addition to charge the thermal mass composition of the green boiler with thermal energy. For example, a solar energy source may circulate a heat transfer working fluid such as molten salt or heat transfer oil through a solar collector and in turn heat exchanger tubes embedded in the thermal mass composition within the green boiler to heat the composition. The solar collector may be a concentrated solar power (CSP) system comprising a centrally-located power tower and array of reflectors (heliostats) which focus sunlight onto one or more thermal receivers that heat the working fluid. Such systems are well known in the art without further elaboration necessary. The heated working fluid flows through heat exchange tubes embedded in the bed of thermal mass composition of the green boiler to heat the bed. Alternatively, or in addition to, a plurality of wind turbines with onboard electric generators may be used which generate electricity that supplies power in turn to energize electric immersions heaters embedded in the thermal mass composition. Such solar collector and wind turbine systems are well known in the art without further undue elaboration necessary. It bears noting that the thermal energy storage system may be configured to switch thermally charging the bed of thermal mass composition between off-peak energy extracted from the power grid when available (e.g., during nighttime hours) and intermittent energy from solar (during daylight hours) or wind (day or night) when available. This significantly adds operational flexibility to thermally charge the green boiler using a power source that is least expensive at a given time period thereby providing considerable economic benefit.

For electric power generation, the green boiler comprising one or more steam generators is configured and functions to boil the boiler feed water (feedwater) and produce high-pressure superheated steam for the Rankine power generation cycle to produce electric power “on demand” whenever the grid faces a deficit of electricity to meet current demand Thus, when the grid faces a power deficit, the green thermal energy storage vessel can serve as a peaking power generation unit further replacing traditional smaller natural gas or diesel peak power generation units used during electric load swing periods of the power grid. In other words, the green thermal energy storage vessel is activated when the power demand exceeds supply available from the base load units in the power grid. Thus, the traditional large “base load” polluting fossil-fueled power plant with fossil-fueled boiler is converted into an on-demand clean energy generator for a peak power generation role.

For district heating applications, the green boiler comprising one or more heat exchangers uses the thermal energy stored in the thermal mass composition bed to heat and produce hot water in one embodiment which may be pumped and distributed to the local town or city for heating buildings. The water is heated such as to about 200 degrees F. (Fahrenheit) and remains in a saturated but un-boiled liquid state for heating purposes.

In other embodiments of a district heating application, the green boiler comprising one or more steam generators may be configured to produce low pressure steam (e.g., less than 150 psig) from water. Such low pressure steam may alternatively also be used for industrial purposes or other applications requiring low pressure steam.

Multiple TES vessels may be arranged and fluidly coupled together in a parallel flow arrangement to supply the total volume of high pressure superheated steam, lower pressure steam, or hot water (or another heat transfer fluid) for the foregoing purposes. Advantageously, this provides a modular system in which additional TES vessels may be added over time as needed to increase power generation capacity at the generation site, increased industrial need for lower pressure steam or heated water, or as the demand for district heating increases with population and infrastructure growth. Accordingly, the present thermal energy storage system provides significant flexibility to accommodate expansion of services and infrastructure.

### BRIEF DESCRIPTION OF THE DRAWINGS

The features of the exemplary embodiments of the present invention will be described with reference to the following drawings, where like elements are labeled similarly, and in which:

FIG. 1A is a schematic diagram of a conventional Rankine power generation cycle system using a polluting fossil-fueled boiler to produce steam;

FIG. 1B is a schematic diagram of a Rankine power generation cycle system including a green boiler comprising a thermal energy storage (TES) vessel according to the present disclosure to produce high steam for the cycle;

FIG. 1C is a schematic diagram of a district heating system including a green boiler comprising a TES vessel according to the present disclosure to produce low pressure steam or hot water for district heating;

FIG. 2 is a top perspective view the TES vessel of the green boiler showing an optional penthouse (structural frame shown only);

FIG. 3 is a side elevation view thereof;

FIG. 4 is a top perspective view of the TES vessel without the optional penthouse to reveal the top headers of the heat exchangers of the vessel;

FIG. 5 is an enlarged view of the top of the TES vessel taken from FIG. 4;

FIG. 6 is a bottom perspective view of the TES vessel;

FIG. 7 is a first side elevation view thereof;

FIG. 8 is a second side elevation view thereof;

FIG. 9 is a third side elevation view thereof;

FIG. 10 is a fourth side elevation view thereof;

FIG. 11 is a top view thereof;

FIG. 12 is a bottom view thereof;

FIG. 13 is a first side cross sectional view thereof;

FIG. 14 is an enlarged view of the top portion of the TES vessel taken from FIG. 13;

FIG. 15 is an enlarged view of the bottom portion of the TES vessel taken from FIG. 13;

FIG. 16 is a second side cross sectional view of the TES vessel;

FIG. 17 is an enlarged view of the top portion of the TES vessel taken from FIG. 16;

FIG. 18 is an enlarged view of the bottom portion of the TES vessel taken from FIG. 16;

FIG. 19 is a top perspective view of the TES vessel with one sidewall removed showing the internal cavity of the vessel and banks of electric heaters and heat exchanger tubing of the heat exchangers of the vessel;

FIG. 20 is an enlarged view of the bottom portion of the TES vessel taken from FIG. 19 showing one of the slideably insertable heaters exploded outwards;

FIG. 21 is an enlarged perspective view of the bottom portion of the TES vessel without sidewalls and heaters in place to reveal the tube bundles of the heat exchangers and tube support structure or frame inside the TES vessel;

FIG. 22 is a schematic diagram of a portion of the TES vessel showing one of the heat exchangers and the tube-side flow path (denoted by flow arrows) of the heat transfer fluid circulating through the tubing of the heat exchanger embedded in a thermal mass composition operable to retain and release heat;

FIG. 23 is a top perspective view of the TES vessel showing the outer thermal insulation in place on the vessel;

FIG. 24 is a side view of a pair of heat exchangers of the TES vessel showing the tube bundles of the heat exchangers in isolation and the tube grid supports;

FIG. 25 is a top view thereof showing the tube grid supports;

FIG. 26 is an enlarged details of the top tubesheet of one of the heat exchangers showing the top portion of a single heat exchanger tube and corresponding discharge extension tube located inside the top header;

FIG. 27 is an additional side elevation view of the TES vessel showing a portion of the sidewall comprised of side plates removed to reveal the internal cavity of the vessel;

FIG. 28 is an enlarged side cross sectional view of the top header of one of the heat exchangers showing the top sheet and a steam demister mounted inside the top flow plenum formed by the header;

FIG. 29 is a schematic diagram showing the inlet and discharge piping networks of the TES vessel which are associated with heat transfer fluid entering and leaving the heat exchangers of the vessel; and

FIG. 30 is a lower cross-sectional view of the TES vessel showing an alternative embodiment of means for heating the thermal mass composition of the vessel comprising immersion heat exchanger units including a heat exchanger tube bundle which convey a heated working fluid through the composition.

All drawings are schematic and not necessarily to scale. Parts given a reference numerical designation in one figure may be considered to be the same parts where they appear in other figures without a numerical designation for brevity unless specifically labeled with a different part number and described herein. References herein to a whole figure number herein which may comprise multiple figures with the same whole number but different alphabetical suffixes shall be construed to be a general reference to all those figures sharing the same whole number, unless otherwise indicated.

### DETAILED DESCRIPTION OF THE EMBODIMENTS

The features and benefits of the invention are illustrated and described herein by reference to exemplary (“example”) embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range. In addition, all references cited herein to prior patents or patent applications are hereby incorporated by reference in their entireties. In the event of a conflict in a definition in the present disclosure and that of a cited reference, the present disclosure controls.

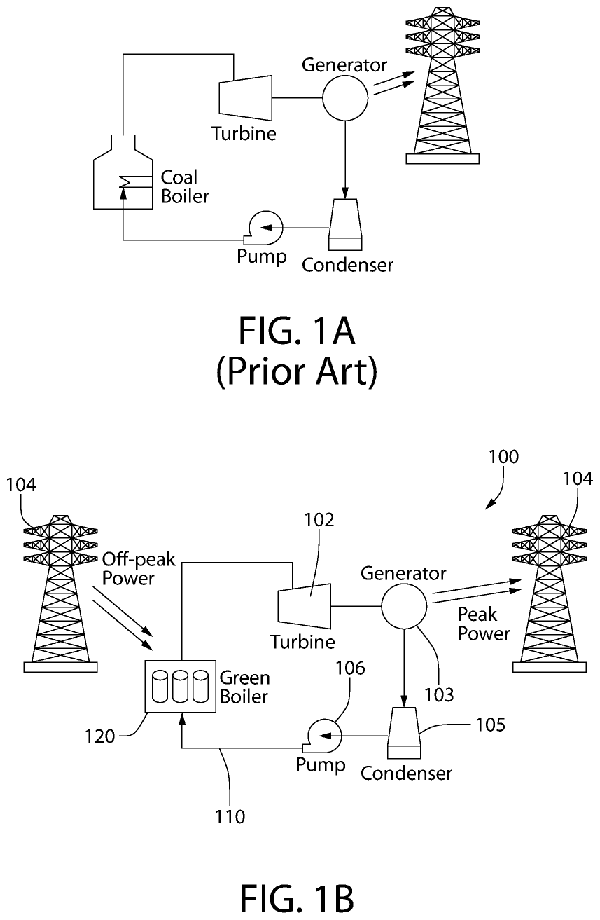

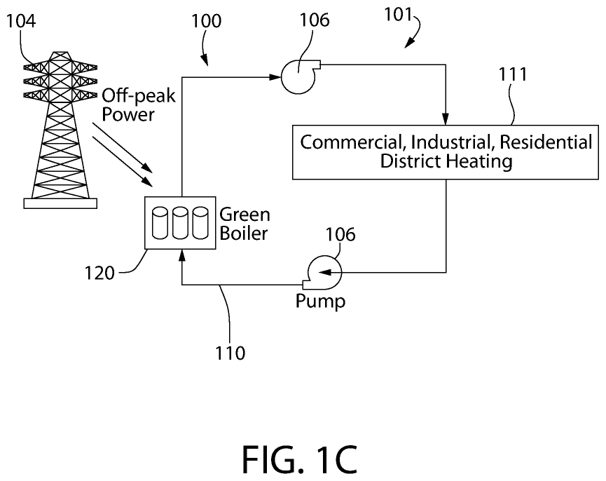

FIG. 1A shows a conventional power generation steam-to-electric Rankine power generation cycle with a large-scale fossil-fueled boiler to generate steam necessary for power production. The basic cycle equipment (excluding auxiliary systems) includes the fossil fuel fired boiler (e.g., coal, oil, or natural gas), steam turbine-generator set, steam condenser which condenses steam exhausted from the steam turbine back into a liquid state, and boiler feedwater pump which takes such from the condenser circulates the boiler feedwater (heat transfer fluid) through a closed flow loop formed by piping which fluidly couples the components together as shown. The electric generator is mechanically coupled to steam turbine and electrically coupled to the power grid (represented by the power line transmission tower shown). Steam produced by the boiler rotates the turbine shaft via the rows of turbine blades, which in turn rotates the rotor of the generator within the stator (magnets) to convert mechanical energy into electric energy in a known manner. The Rankine cycle power generator system and its operation for generating electric power is well known to those skilled in the art without further elaboration necessary.

The fossil-fueled boilers in Rankine systems which convert the boiler feedwater in a liquid state to high pressure steam are traditionally used for base electric load operation to satisfy the base load demand of the power grid since such boilers and associated auxiliary equipment cannot be quickly started for on-demand power generation. In fact, the entire startup process for fossil-fueled base load plants takes many hours to bring all equipment and the system up to full pressure and temperature operating conditions to reach full load.

FIG. 1B depicts a clean energy “green” Rankine power generation cycle system including a green boiler 120 according to the present disclosure. The green boiler, which is a thermal energy storage device in part, replaces the fossil-fueled steam boiler of FIG. 1A with a thermal energy containment vessel 130 which is configured as both a containment for the thermal mass composition which retains heat and one or more heat exchangers, as further described herein.

The present thermal energy storage system 100 used for power generation in FIG. 1B comprising green boiler 120 may be configured and used as a “peaking” power generation system to generate and supply power to the power grid during peak load demand periods. The green boiler can quickly initiate operation “on demand” to produce the steam required to run the Rankine cycle. Preferably, electric energy used to “charge” and heat the thermal mass composition is extracted from the power grid during “off-peak” load demand periods if possible when there is a surplus of energy in the grid.

The green thermal energy storage system 100 shown in FIG. 1B may include without limitation a conventional steam turbine-generator set including steam turbine 102, electric generator 103 mechanically coupled thereto and operably connected to the electric power grid 104, steam condenser 105, boiler feedwater pump 106, and the green boiler 120 which contains thermal mass composition operable to absorb and release heat on demand. The generator generates electricity in a conventional manner via a stator and rotor assembly as well known in the art. The feedwater pump circulates the boiler feedwater through closed flow loop 110 formed by a flow conduits such as piping which fluidly couples the water bearing components of the Rankine cycle together as shown. With exception of the present green boiler assembly, the remaining balance of plant components of the clean energy Rankine cycle operate in the same foregoing and known manner as a traditional Rankine cycle to produce electricity.

FIG. 1C shows the application of a green boiler 120 according to the present disclosure for a thermal energy storage district heating system 101 which may include commercial, industrial, and residential space heating uses. Hot water or low pressure steam generated by the green boiler is pumped via one or more pumps 106 through closed flow loop 110 to multiple end use points requiring space heating (e.g., radiators, etc.). A district heating flow distribution network 111 is collectively represented by the box in FIG. 1C and may include residential and commercial heating end uses. After yielding its heat for space heating, the now cooled water (or condensate of a low pressure steam district heating system) is collected and flows back to the green boiler through flow loop 110 where it is reheated and continues the same heating and distribution cycle repetitively.

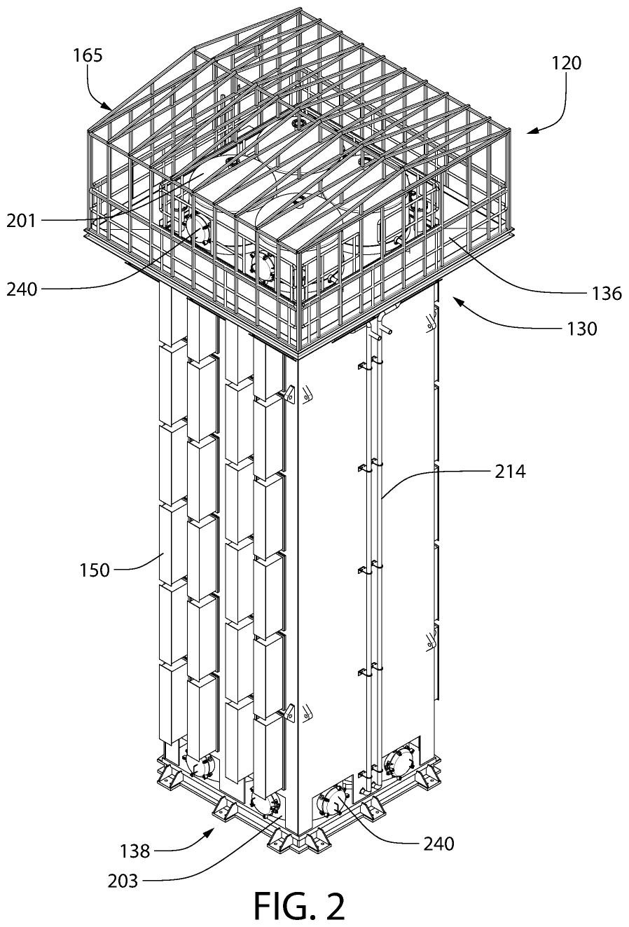

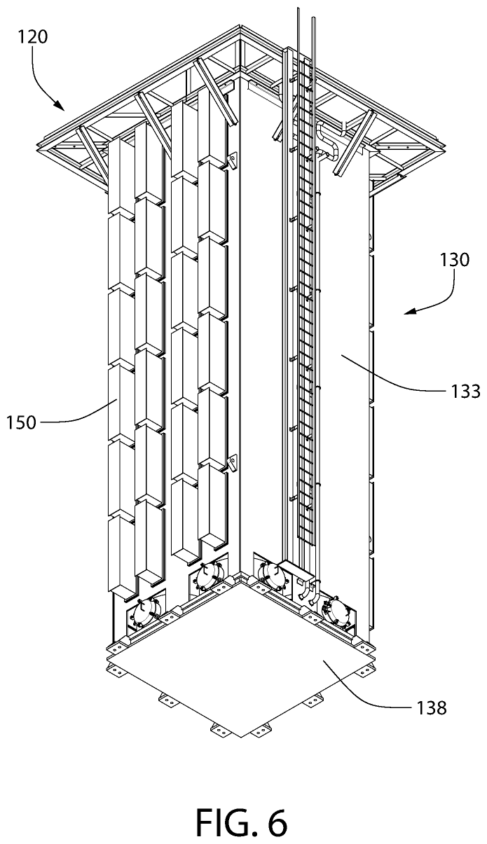

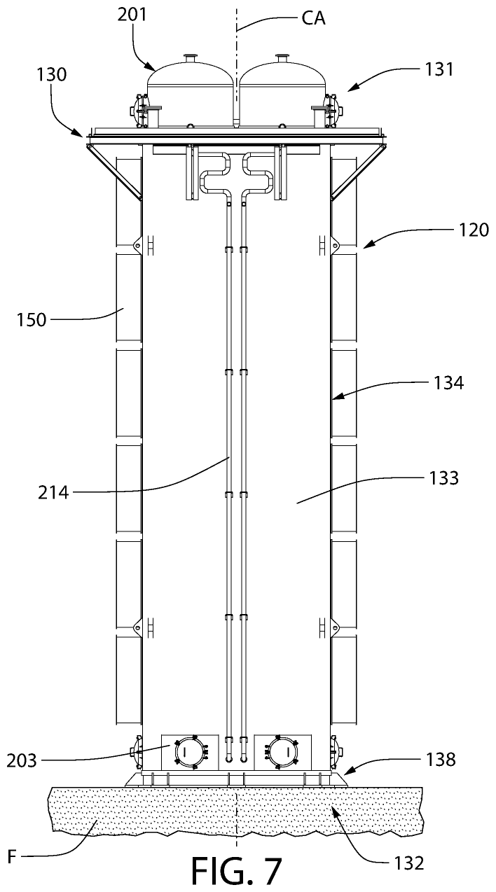

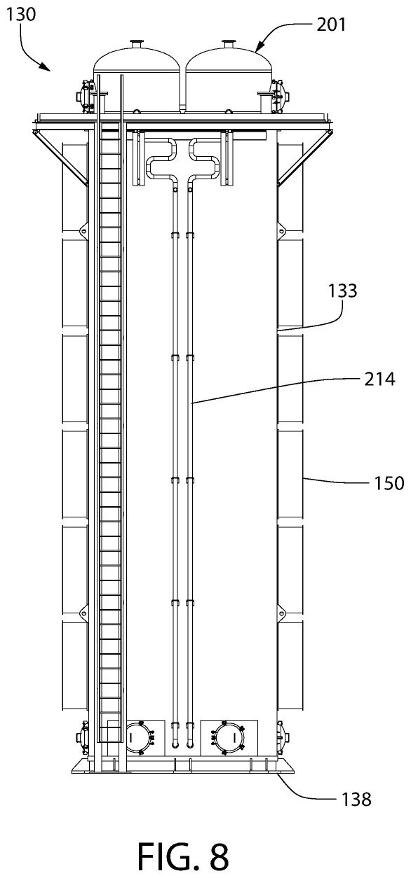

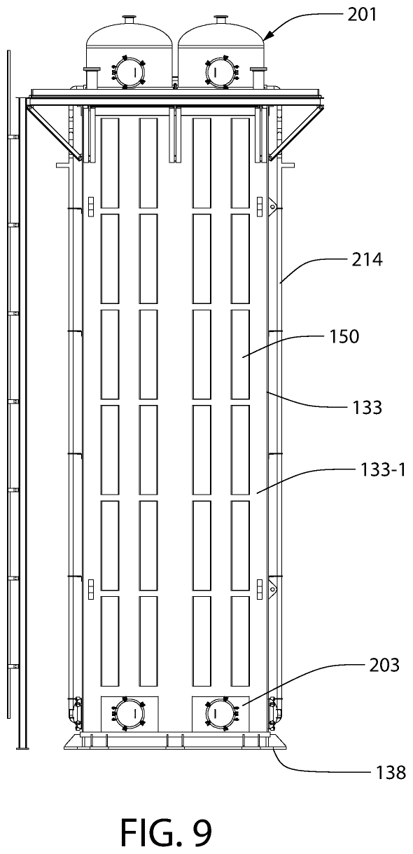

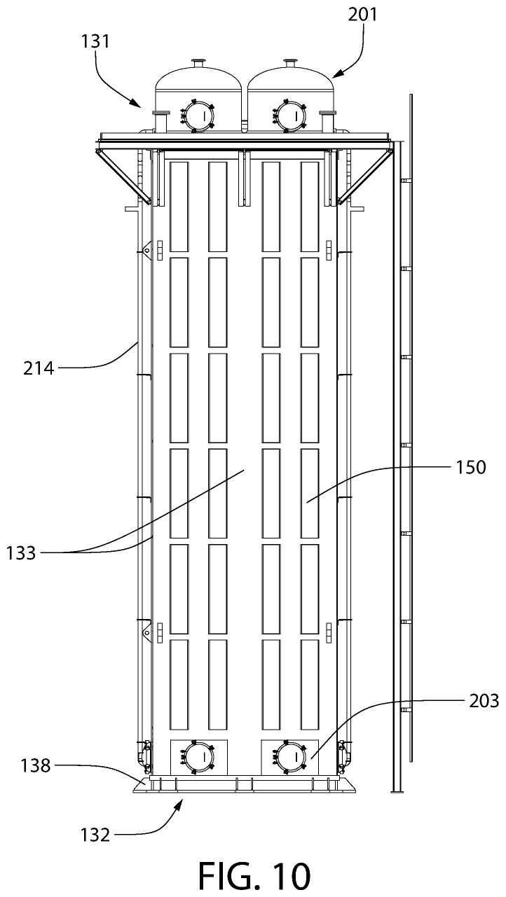

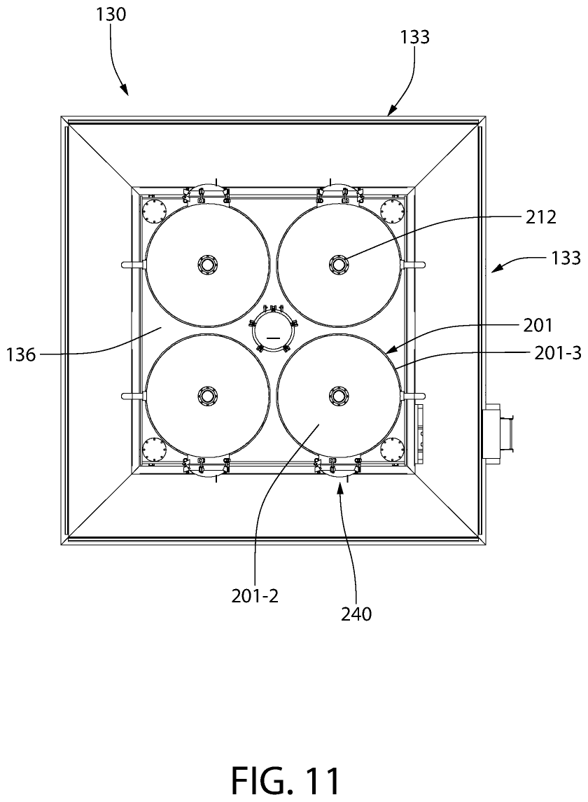

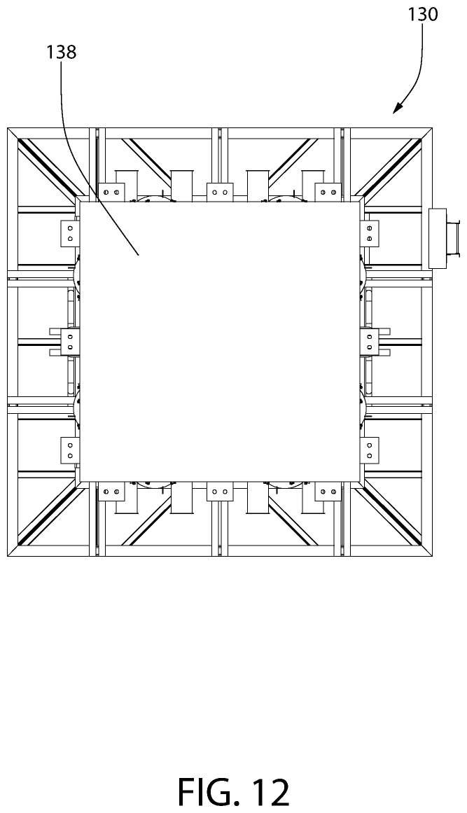

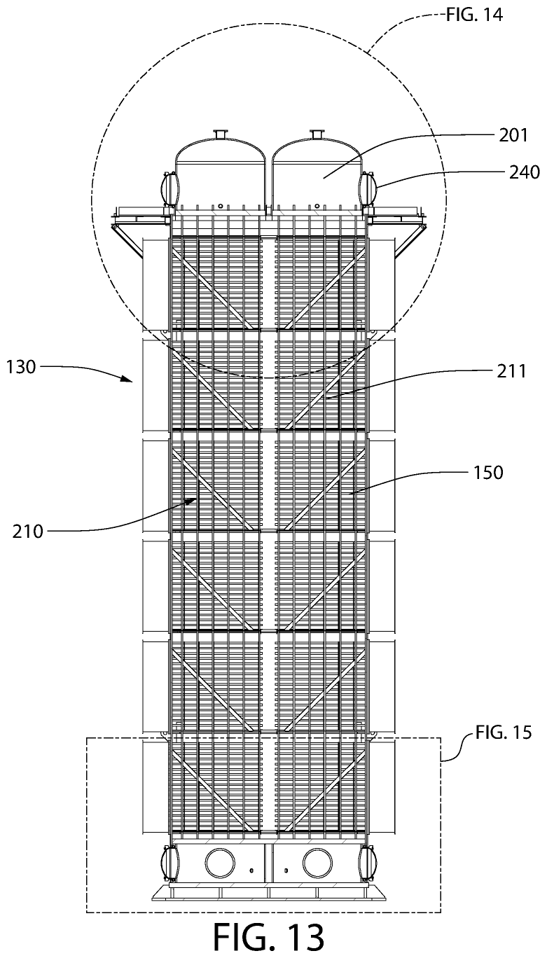

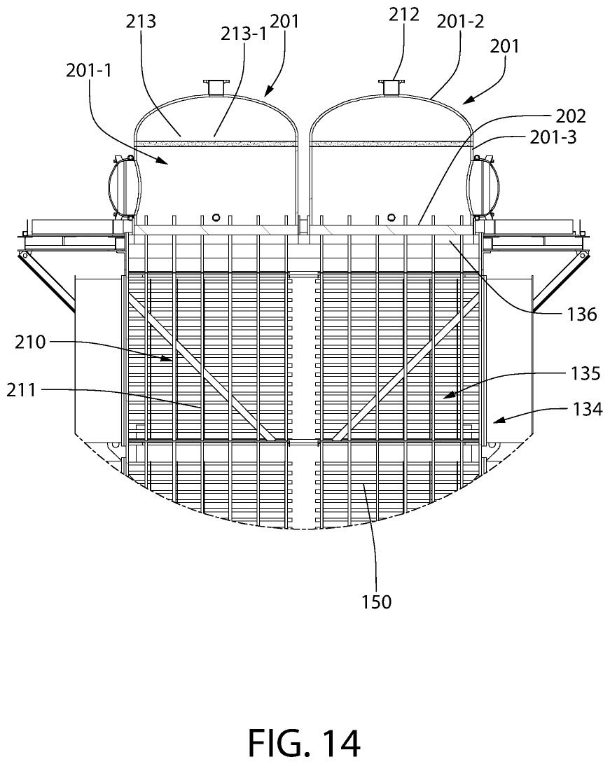

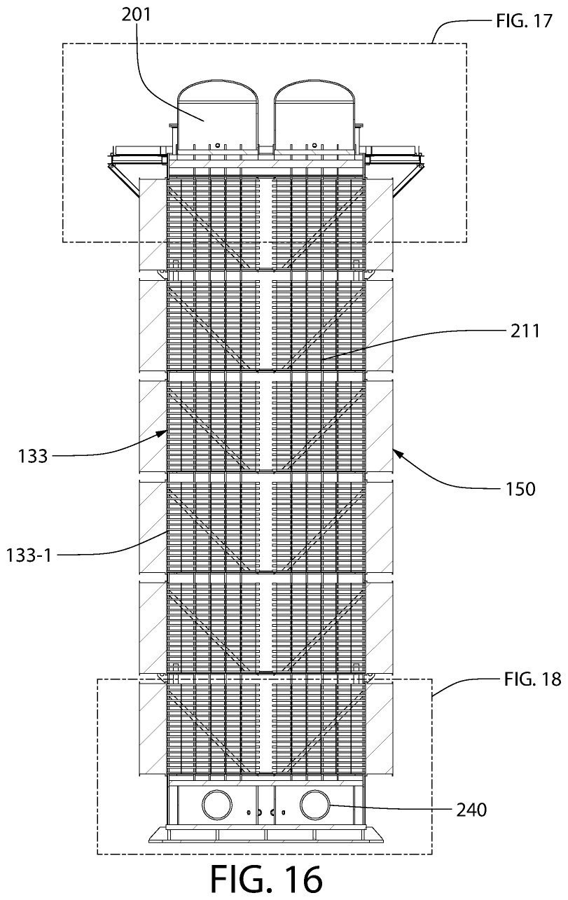

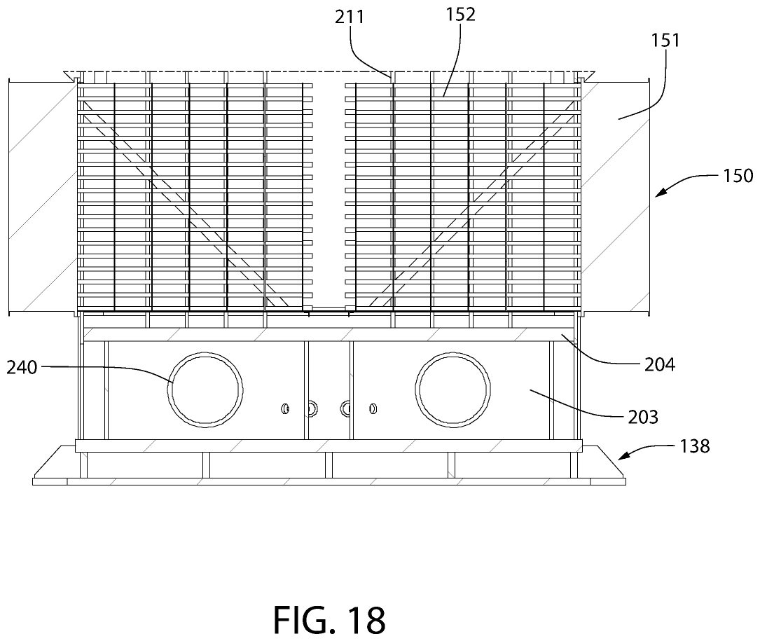

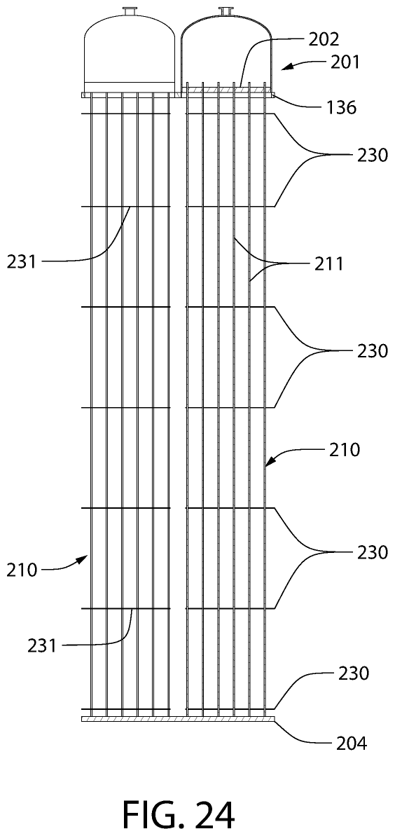

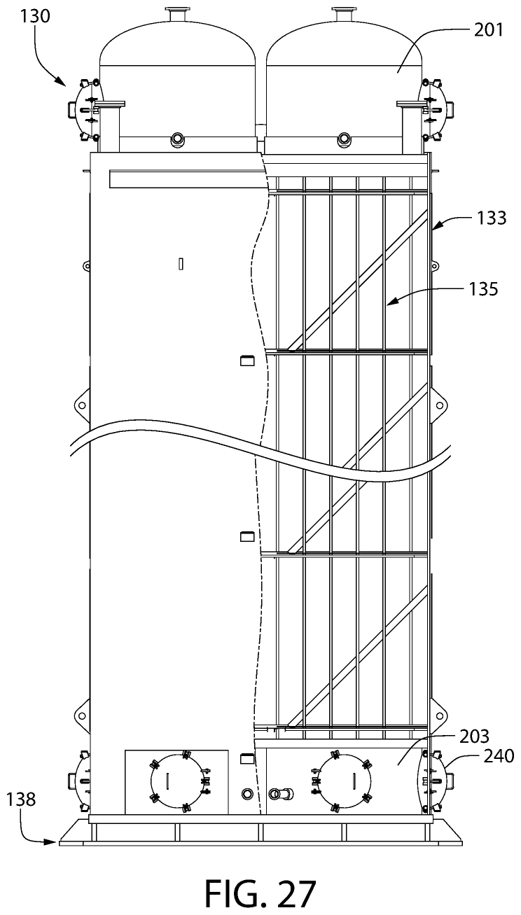

FIGS. 2-28 show various aspects of a thermal energy storage system according to the present disclosure which may be used for power generation, district heating, or other uses. The system has broad applicability and is not limited in its application for various purposes to provide hot water or low/high pressure steam. Steam pressures in the range from about and including 50 psi up to about and including 3000 psi can be produced to meet a variety of steam needs and applications.

The thermal energy storage system includes green boiler 120 comprising heavily insulated thermal energy storage (TES) vessel 130 in combination with one or more heat exchangers 200 operable to heat a heat transfer fluid. In the non-limiting illustrated embodiment, the heat exchangers may each be a steam generator 200-1 configured and operable to heat water and produce steam for power generator, district heating, or industrial uses as some examples. In other embodiments, the heat exchangers may each be configured and operable to simply increase the temperature of the heat transfer fluid such as water or another which remains in a liquid state before and after heating. For district heating uses, the TES vessel and heat exchanger design may be similar to the steam generator 200-1 including the same features shown with exception that the demister (further described herein) which dries the outgoing steam flow is of course not necessary and may be omitted. The other features of the TES vessel and heat exchanger may remain the same as described below. Accordingly, the steam generator will be described in a broad context using the more generic terminology of a “heat exchanger 200” which can be used for either steam generation or simply raising the temperature of a heat transfer fluid which remains in a liquid state after heating.

Heat exchangers 200 are integrated directly into the housing 134 of the vessel to form a singular green boiler unit (as further described herein). Advantageously, this provides a modular boiler unit which has a small footprint at the installation site and facilitates shipping/transport as a single unit that can be shop fabricated including all coupled (e.g., welded, flanged/bolted, threaded, etc.) internal piping and tubing connections. This enhances reliability and decreases installation time at the install site. The singular unit construction of the green boiler 120 is therefore distinct from physically separate and discrete thermal storage vessels and heat exchangers which must be assembled and piped together on-site in the field.

TES vessel 130 is vertically elongated and oriented structure which may have a generally box-shaped body and construction. For example, TES vessel 130 may have a rectangular cuboid configuration as shown in the non-limiting illustrated embodiment. Other shaped vessels may be used including for example without limitation hexagonal shapes, cylindrical shapes, and others. The shape of the vessel does not limit the concepts or invention disclosed herein.

TES vessel 130 defines a vertical centerline axis CA which passes through the geometric center of the vessel. This axis defines a point of reference to facilitate description of other components of the vessel and relative orientations between components.

The TES vessel generally comprises an outer housing 134 defining a top 131, bottom 132, and plurality of vertical sidewalls 133 extending between the top and bottom along axis CA. The sidewalls may be flat and formed by a plurality of suitable metal side plates 133-1 in one embodiment (e.g., steel or aluminum) attached to an internal structural steel skeletal framework (not shown for clarity to depict the working internal components of the vessel). Four sidewalls 133 are provided, which are each oriented perpendicularly to adjacent sidewalls that meet at 90 degree corners 133-2. The framework may comprise suitable vertical, horizontal, and angular structural steel members and bracing as needed to support the vessel and its appurtenances.

The TES vessel 130 further comprises a structural support base 138 disposed on the bottom 132 of the vessel housing 134. Mounting base 138 may be a generally horizontal and broadened structure of rectilinear shape which is configured for placement on and securement to a flat support structure such as concrete foundation slab F. In one embodiment, bolting to the slab using a plurality of threaded fasteners or anchors (not shown) which can be inserted through holes provided in gusseted mounting plates 138-1 on all four sides of the base may be used. The mounting base 138 may be formed of a suitably strong horizontal and vertical flat metal plates and structural members of appropriate thickness such as steel to form the mounting base configuration shown in a manner which supports the entire weight of the TES vessel from the foundation slab.

TES vessel 130 further comprises a generally flat horizontal top closure plate 136 at the top 131 and generally flat horizontal bottom closure plate 137 at bottom 132 of the vessel. Plates 136, 137 are formed of a suitable thick metal such as steel or other. The top and bottom closure plates are oriented parallel to each other and oriented perpendicularly to vessel centerline axis CA. Both plates extend completely from side-to-side of the vessel 130 and outer housing 134 as shown. Accordingly, top and bottom closure plates 136, 137 may each have a generally rectilinear (i.e. square or rectangular) shape as opposed to the top and bottom header 201, 203 structures which are cylindrical, as further described herein. The bottom closure plate 137 is fixedly coupled to and supported by the support base 138 of the vessel previously described above.

The TES vessel 130 (e.g., housing 134) defines an open and continuous/contiguous vertical internal space or cavity 135 extending vertically between the horizontal top closure plate 136 and bottom closure plate 137 along centerline axis CA and laterally/horizontally between the four sidewalls 133 (i.e. side plates 133-1) of the TES vessel housing 134. Cavity 135 therefore extends for at least a majority, and substantially the entire height of the vessel housing 134 in the illustrated embodiment (excluding the thickness of the top and bottom closure plates of the housing).

Internal cavity 135 of TES vessel 130 is filled with the thermal mass composition M (further described herein) which is operable to absorb and retain heat from the heaters embedded in the material. The thermal mass composition is contained in a captive state within the vessel 130 such that the material does not flow into or out of TES vessel 130 during operation of the green boiler 120. Only the heat transfer fluid on the tube-side flows through the vessel, as further described herein.

The heat exchangers 200 of TES vessel 130 will now be described in further detail.

With continuing general reference to FIGS. 2-28, one heat exchanger be disposed in each of four quadrants of the thermal energy storage vessel forming four fluid heating zones. Each heating zone is independently operable of the other for heating the heat transfer fluid since the heat exchangers 200 are fluidly isolatable from each other, as further described herein. This provides considerable operational flexibility since only some of the heat exchangers may be needed at various times to supply enough steam or heated liquid heat transfer fluid to meet the end use applications demand.

Each heat exchanger 200 generally comprises a top channel or header 201 including a top tubesheet 202, and bottom channel or header 203 including a bottom tubesheet 204. Top header 201 is disposed at the top 131 of TES vessel 130 and bottom header 203 is disposed at the bottom 132 of the vessel. Each tubesheet 202, 204 may have a circular shape in one embodiment.

Each heat exchanger 200 further comprises a tube bundle 210 including a plurality of elongated heat exchanger tubes 211 extending vertically between the top and bottom tubesheets 202, 204. Tubes 211 may be linear and straight tube in one embodiment as shown. The tubesheets are relatively thick structures, such as for example about 4 inches thick in one embodiment. The top ends of the tubes are fixedly and sealably coupled to the top sheet 202 via circumferential seal welds. It bears noting that the tubes 211 pass through complementary configured holes in the top plate 136 but are not fixedly attached thereto and slideable relative to the top plate.

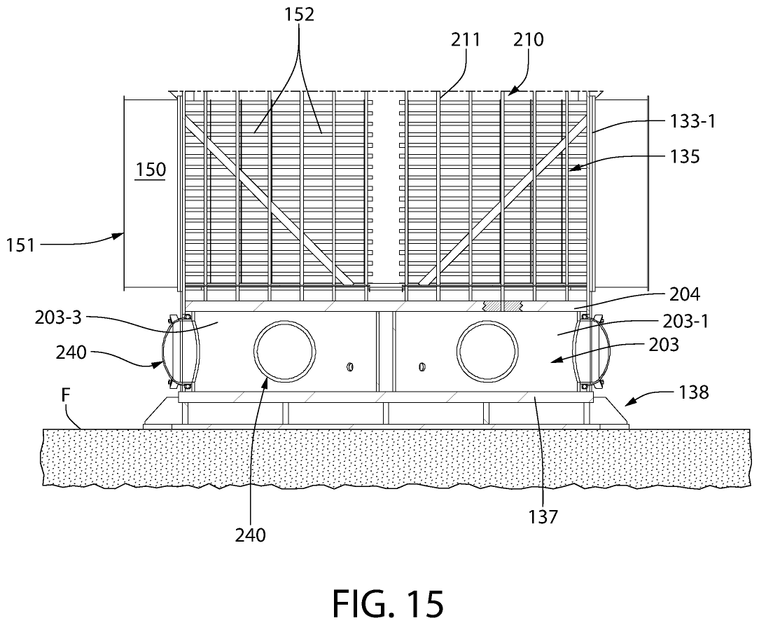

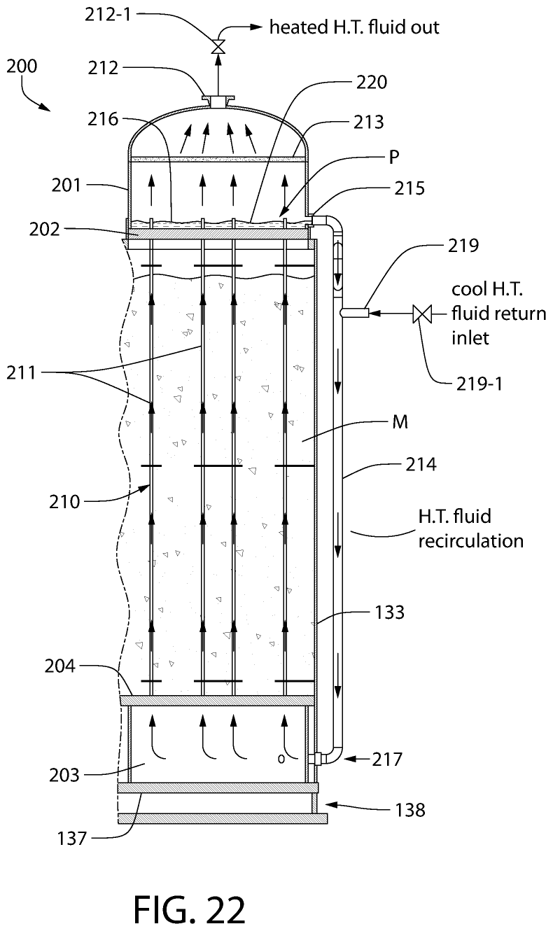

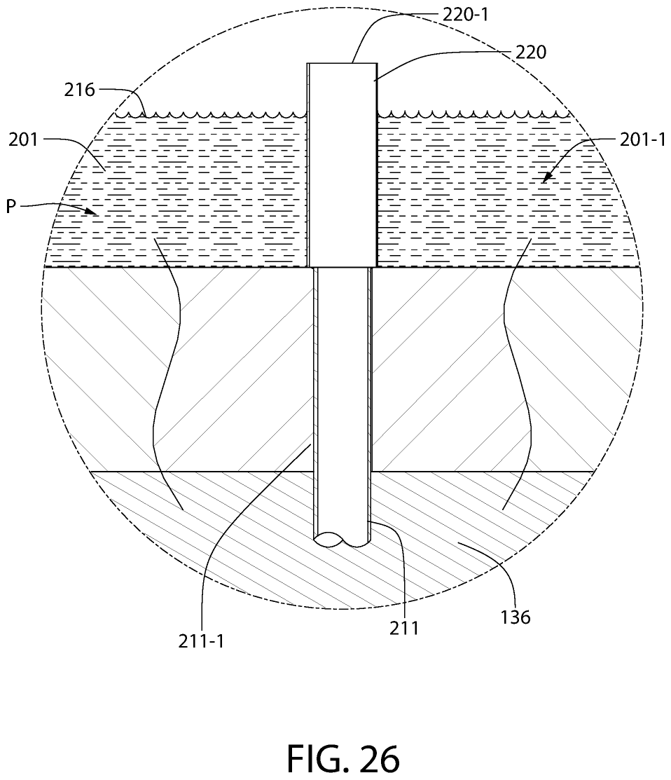

In a similar vane to the top tubesheet 202, the bottom ends of the tubes 211 are fixedly and sealably seal welded to the bottom tubesheet 204 in the same manner. The tubes 211 extend completely through the top and bottom tubesheets in complementary configured through holes 211-1 (see, e.g., FIG. 26 showing the top tubesheet to tube interface). A similar construction with through holes is used for the bottom ends of tubes and bottom tubesheet 204 (see, e.g., FIG. 15). This places each heat exchanger tube 211 in fluid communication with both the top and bottom headers 201, 203 to allow flow of the heat transfer fluid to be exchanged therebetween (see, e.g., FIG. 22 showing the tube-side heat transfer fluid circulation pattern flow denoted by flow arrows).

The top header 201 defines an open internal space which forms a top flow plenum 201-1 of the heat exchanger. Bottom header 203 similarly defines an open internal space which defines a bottom flow plenum 203-1. The heat transfer fluid (e.g., water or other) flows inside the tubes 211 of the tube bundle 210 on the tube-side of the tubes. Bottom flow plenum 203-1 receives the heat transfer fluid in a cooled liquid state and distributes the fluid to the inlet bottom ends of each tube 211 in the tube bundle 210. In a similar fashion, top flow plenum 201-1 receives and collects the heat transfer fluid from outlet top end each tube 211 after it has been heated by the thermal mass composition inside the TES vessel 130. Accordingly, as shown in the flow diagram of FIG. 22, the flow of the heat transfer fluid inside the tubes 211 in the present embodiment is vertically upward in the vessel from the bottom header 203 to the top header 201.

The heat exchanger tubes 211 are embedded in the thermal mass composition M which fills the gaps or voids between the tubes of the tube bundle 210 such that the thermal mass composition is in direct conformal contact with the outer surface of the tubes for optimum heat transfer. Thermal mass composition M will be further described herein.

In one non-limiting embodiment, both top and bottom headers 201, 203 may comprise a generally tubular-shaped and hollow cylindrical metal body in structure formed by a respective vertically oriented annular shell 201-3, 203-3. The shells define circumferentially-extending vertical sides of the headers as shown. Shell 203-3 of the bottom header 203 extends vertically and is welded and sandwiched between bottom tubesheet 204 at top and bottom closure plate 137 of the TES vessel housing 134 at bottom. Accordingly, the top and bottom ends of shell 203-3 are seal welded to the bottom tubesheet and bottom closure plate respectively of the housing to form a leak-tight bottom flow plenum 203-1 inside bottom header 203. This fixes the bottom tubesheet 204 in position in the vessel.

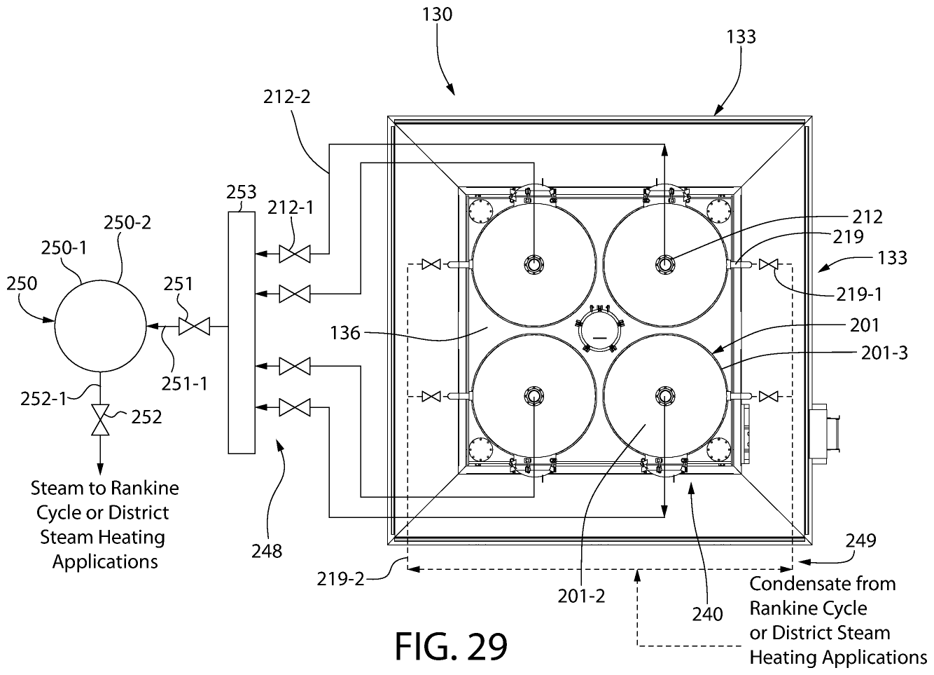

Shell 201-3 of top header 201 protrudes upwards from top closure plate 136 of the TES vessel housing. A domed head 201-2 is seal welded to the top end of shell 201-3 to form a leak-tight top flow plenum 201-1 inside top header 201. In some implementations, the head may be an elliptical or hemispherical head; however, other domed structures may be used. A fluid outlet 212 in the form of a protruding short piping section is disposed on the domed head of each top header for discharging the heated heat transfer fluid (in liquid or steam form) from the top header. Heat transfer fluid flow out of TES vessel 130 is controlled by fluid outlet valve 212-1 (see, e.g., FIG. 22). Fluid outlet 212 in one embodiment may be centered at the top of the head to collect the heat transfer fluid in liquid or steam phase exiting TES vessel 130 after being heated. The fluid outlets from each heat exchanger may be fluidly coupled together to form a single heated heat transfer fluid stream (see, e.g., FIG. 29 further described herein) which exits the vessel and enters the closed flow loop 110 such as those shown in FIGS. 1B and 1C.

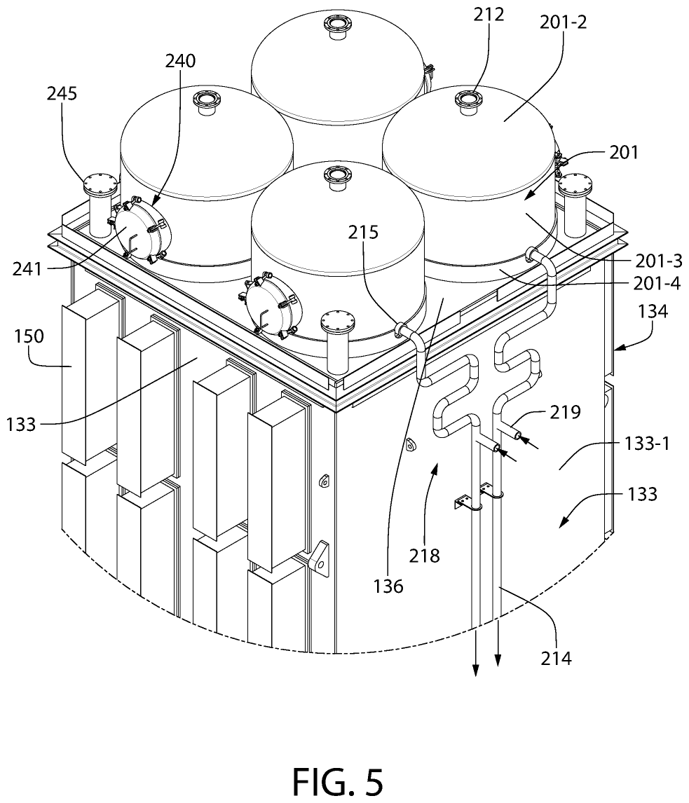

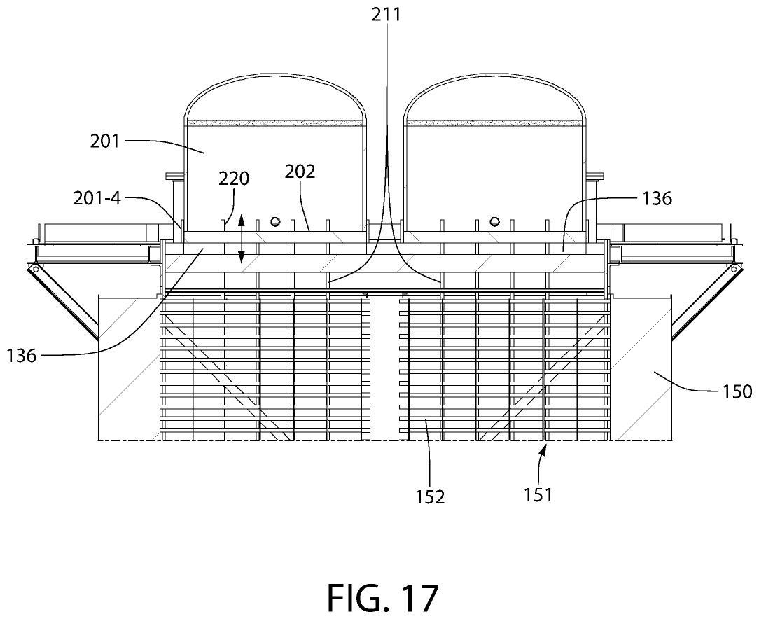

To account for vertical thermal growth of the tubes 211 in the tube bundles 210 of the four heat exchangers 200 as the heat transfer fluid is heated in TES vessel 130, a floating tubesheet design is provided for top tubesheet 202. The circular top tubesheet 202 is surrounded by a metallic annular thermal expansion sleeve 201-4 welded at its bottom to the top closure plate 136 of the TES vessel (see, e.g., FIGS. 5, 17, and 28). Specifically, the bottom end portion of vertical shell 201-3 of the top header 201 is sealed to the top surface of top tubesheet 202 in a fluid tight manner by a circumferential seal weld. The top header shell 201-3 and top sheet 202 weldment is slideably disposed inside the expansion sleeve 201-4 as shown. When the tubes are heated by thermal mass composition M and thermally grow/expand linearly in length from their initial cold condition, both the tubesheet 202 and entire top header 201 structure move/rise vertically upwards relative to top closure plate 136 of TES vessel 130 which remain stationary (see, e.g., directional thermal growth/contraction arrow in FIG. 17). It will be recalled that the bottom tubesheet 203 is stationary relative to the TES vessel housing 134. As the thermal mass composition M cools as its heat is transferred to the heat transfer fluid flowing inside the tube bundles 210, the tubes 211 will begin to shrink. Tubesheet 202 and top header 201 (including cylindrical shell 201-3) will slide back down inside thermal expansion sleeve 201-4. In contrast to conventional shell and tube heat exchangers in which both the tube-side and shell-side of the vessel is pressurized above atmospheric pressure, the internal cavity 135 of TES vessel 130 is at ambient atmospheric pressure. Therefore, the thermal expansion sleeve alone with a preferably relatively tight fit to the tubesheet and top header shell 201-3 (i.e. minimal annular clearance) is sufficient to provide a non-pressurized sealing interface.

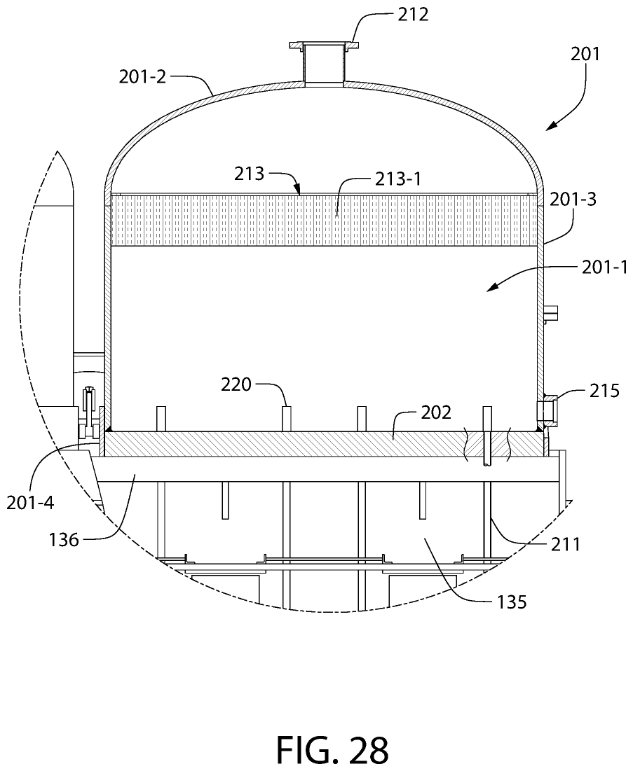

According to another aspect of the invention, in applications where the TES vessel 130 heats water which is converted into steam on the tube-side of the heat exchanger tubes 211 of tube bundle 210, a demister 213 may be provided. FIG. 28 is an enlarged cross-sectional view of the top header 201 and demister 213. The demister serves to condition and dry the steam before exiting the top header 201 through fluid outlet 212, thereby increasing “steam quality” (proportion of saturated steam present in a saturated liquid/steam (vapor) mixture). Higher quality steam typically provides greater heat transfer efficiency, and is therefore desirable.

In one embodiment, demister 213 may be formed by an expanded metal mesh panel 213-1 comprising plural openings between the mesh wire through which the steam can pass and flow. The collected carryover water droplets entrained in the steam condenses on the metal mesh and falls by gravity from the demister downwards onto the top tubesheet 202 inside the top header 201/flow plenum 201-1 (see, e.g., FIG. 22). The collected water (e.g., condensate) is drained away and out from the top header by a vertical downcomer 214 fluidly coupled to top header 201 such as via a drain outlet 215 coupled to the shell 201-3 of the header as shown. The downcomer may be formed by a pipe in one non-limiting embodiment which may be located outside housing 134 of the TES vessel adjacent to the sidewalls 133 of the housing. The bottom end of each downcomer 214 is fluidly coupled to the bottom header 203/flow plenum 203-1 via a header fluid inlet 217 to return the drainage thereto. The fluid inlet may be formed by a short section of piping. Accordingly, a flow circulation loop is formed by the downcomer 214 between the top and bottom headers 201, 203 and the tube bundle 110 as shown in FIG. 22. In the flow circulation loop, a portion of the heated heat transfer fluid existing the top ends of the tubes in the top header 201 is recirculated through downcomer 214 back to the bottom header 203, as further described herein. Drain outlet 215 on top header 201 at top of the downcomer 214, which may also be formed from a short section of piping, is located at an elevation proximate to the top surface of the top tubesheet 202 for reasons which will become evident immediately below.

It bears noting that the collected condensate water inside the header 201 will pond forming a shallow condensate pool P with a defined surface level 216 (see, e.g., FIG. 22). To prevent remixing and rewetting the steam exiting the heat exchanger tubes 211 into top header 201 with the ponded/pooled water therein, each tube is provided a respective metal discharge extension tube 220 of sufficient length (e.g., height) having an open top end 220-1 located at an elevation above the surface level 216 of the condensate pool P. FIGS. 26 and 28 show details of the extension tubes. Establishing the height of the extension tubes may take into account any anticipated fluctuation of the surface level 216 of the condensate pool P in the top header. Extension tubes 220 are each welded at their bottom ends to the top surface of top tubesheet 202 around each heat exchanger tube 211 and protrude vertically upwards therefrom for a distance. A circumferential seal weld is formed at the top surface of tubesheet 202 around the top end of each heat exchanger tube 211 and its respective extension tube 220 such that the tube is in direct fluid communication therewith. The drain outlet 215 of the top header 201 is located in elevation at a point where the pooled water will exit the outlet before being able to enter the top end of the discharge tube and mix with the upward and outward flowing steam. Top ends 220-1 of the extension tubes 220 therefore have an elevation greater than the surface level 216 of the condensate pool P, which is set and fixed by the elevation of the top header drain outlet 215 as noted above.

In one embodiment, the drainage of the heat transfer fluid from the top headers 201 of each heat exchanger 200 through their respective downcomers 214 to the bottom headers 203 creates a natural passive convective thermo-siphon circulation flow loop resulting from heating the heat transfer fluid within the heat exchanger tubes 211 inside the TES vessel 130 (see, e.g., heat transfer fluid flow arrows FIG. 22). This creates natural gravity and heating induced fluid circulation on the tube-side between the headers 201, 203 and through the tube bundle 210 of each heat exchanger 200 which is not powered by mechanical pumps. A fluid which is heated becomes less dense and rises which powers the circulation flow. The thermo-siphon effect principle is well understood by those skilled in the art without further undue elaboration.

The flow of heat transfer fluid through the TES vessel and tube bundles 210 may be in a vertically upward direction and straight path as shown which takes advantage of the natural thermo-siphon effect and gravity. The rising heat transfer fluid as it is heated in tubes 111 of the tube bundle 110 passively draws incoming cool heat transfer fluid returned from the power generation or district heating systems of FIG. 1B or 1C (or others) into the bottom header 203 and tube bundle 110 from the downcomer 214 coupled to return fluid inlet 219 and the top header 201 advantageously without the need for or use of pumps.

In lieu of external downcomer 214, in some embodiments the downcomers may be defined by some of the heat exchanger tubes 211 inside TES vessel 130 which may be located in cooler regions of the vessel.

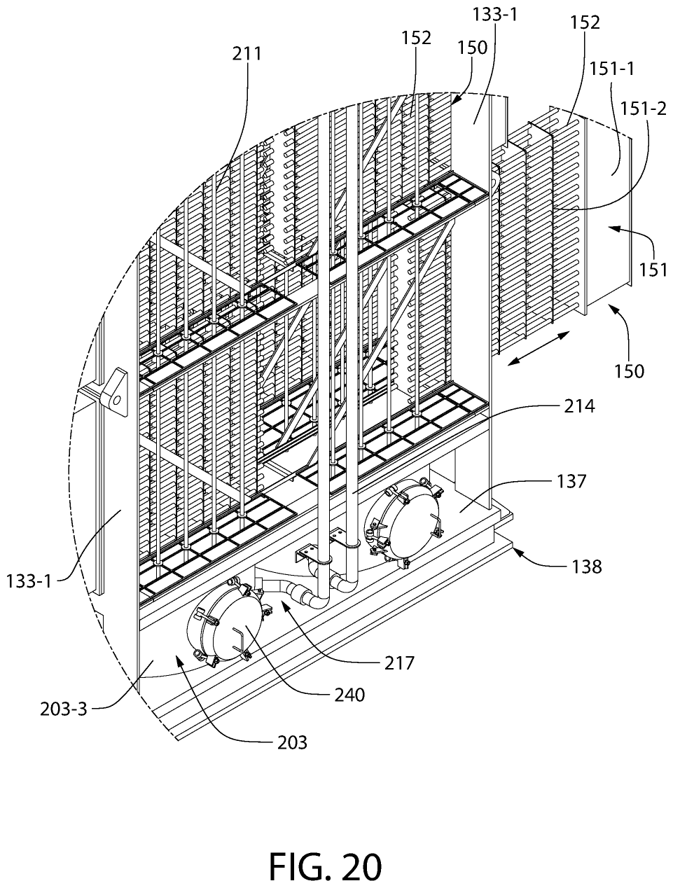

After the hot heat transfer fluid (in liquid or steam form) leaves the TES vessel 130 via the fluid outlet 212 of each heat exchanger 200 and yields it heat for power generation, district heating, or other uses, the cooled heat transfer fluid is circulated back to the TES vessel via the closed flow loop 110 previously described herein (see, e.g., FIGS. 1B and 1C). The returning cool or cooled fluid in the closed flow loop 110 may be piped directly into each downcomer 214 of the four heat exchangers 200 as shown for example in FIGS. 5 and 22 via a return fluid inlet 219 fluidly connected to each downcomer. Heat transfer fluid flow into TES vessel 130 is controlled by fluid inlet valve 219-1 (see, e.g., FIG. 22). The returning cooler heat transfer fluid from closed flow loop 110 mixes with the heated condensate circulation flowing downwards in the downcomers from the top headers 201 of each heat exchanger 200 and then enters the bottom headers 203 via the fluid inlet 217 connections (see also FIG. 20). A single stream enters the bottom headers 204 thereby requiring only a single fluid inlet 217 connection on each bottom header. In addition, a blended heat transfer fluid temperature results upstream of the bottom headers which ensures that heat transfer fluid of uniform temperature enters the bottom headers to eliminate any fluid temperature variations in different portions of the bottom flow plenum 203-1 within these headers. Alternatively in other possible embodiments, however, a separate and discrete return fluid inlet 219 may be fluidly connected directly to each heat exchanger bottom header 204 which is distinct from and in addition to the downcomer piping return fluid inlet connections (i.e. fluid inlet 217 connections) formed on the bottom headers. Either fluid return arrangement is possible.

To accommodate the upward/downward growth of the top header 201 and floating tubesheet 202 resulting from thermal expansion/contraction of the heat exchanger tubes 211 in length during operation of TES vessel 130, the downcomers 214 of each heat exchanger 200 may be provided with a thermal expansion feature 215. In one embodiment, the expansion feature 215 may comprise an undulating and recurvant piping loop which forms one or two sections of C-shaped piping. The undulating piping sections add inline flexibility to the downcomer piping which accommodates the upward/downward thermal movement of the drain outlet 215 with the shell 201-3 of top header 201 to which it is coupled, thereby preventing the development of thermal stress related cracks in the downcomer piping. In other possible embodiments, a commercially-available piping expansion joint such a metal bellows type expansion joint or other type expansion joint may be provided instead of the recurvant piping loops.

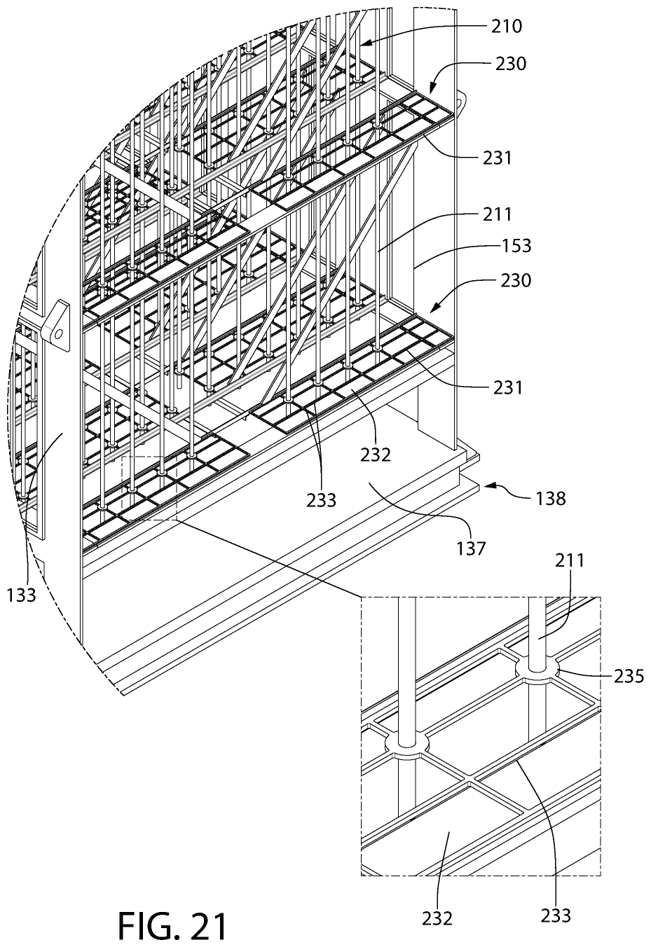

To provide support for the tube bundles 210 of each heat exchanger 200 inside TES vessel 130, a plurality of tube grid supports 230 may be disposed inside internal cavity 135 of the vessel. Referring to FIGS. 21 and 24-25, the tube grid supports may each comprise an open tube support frame 231 collectively formed by various metal structural frame members 233 (e.g., square or circular tubes, rods, C-sections, angles, etc. and combinations thereof) welded together in an orthogonal grid to form open areas 232 therebetween. The open areas allow the granular thermal mass composition M to flow and fill between frame members when the TES vessel 130 is unheated. Advantageously, this forms a continuous and contiguous bed of material M inside the TES vessel 130 which extends for the full height of internal cavity 135 of the vessel.

A plurality of horizontally spaced apart tube lateral support collars 235 are welded to each support frame 231 at intervals which forms the tube layout of each tube bundle 210. The tubes 211 extend through but are each slideably disposed inside a respective collar to allow the tubes to grow/contract vertically upwards/downwards during operation of TES vessel 130. The collars 235 therefore provide lateral support of the tubes, but do not restrain the vertical growth/contraction of the tubes. In addition, lateral support collars 235 act to maintain the horizontal spacing of the tubes 211 inside the bed of thermal mass composition M within the TES vessel. Each tube bundle 210 of the heat exchangers 200 is supported at multiple elevations from the top to bottom of the vessel internal cavity 135 by multiple support frames 213 spaced vertically apart along the height of the tube bundle between the top and bottom tubesheets 202, 204 as shown. Appropriate vertical spacing or intervals may be provided for the tube support frames 231. Each support frame 213 may have a rectilinear and horizontally elongated configuration (e.g., rectangular) as shown in the non-limiting illustrated embodiment. Other shapes and forms of tube support frames may be provided.

Each of the four heat exchangers 200 shown in the non-limiting illustrated embodiment are fluidly isolated from each other on the tube-side which conveys the heat transfer fluid through the thermal mass composition M inside TES vessel 130. Advantageously, this allows one heat exchanger to be taken out of service for maintenance/repair (e.g., plugging tubes) while the remaining heat exchangers continue to be fully functional, thereby allowing TES vessel 130 to continue operation. In addition, for operational flexibility which is significant, the heat transfer fluid demand (whether heated liquid or steam) may not require operation of all four heat exchangers 200 all the time. Accordingly, each heat exchanger 200 and associated discharge and inlet piping network is advantageously configured to be fluidly isolatable from all other heat exchangers so that each heat exchanger can operate independently of the others.

One non-limiting example of a fluid discharge piping network 248 having a configuration allowing selective isolation of each heat exchanger 200 on the discharge side is shown schematically in FIG. 29. The illustrated embodiment depicts a steam production application, but is equally applicable to production of a heated heat transfer fluid in a liquid state. Each heat exchanger in the illustrated embodiment is an independently operable “steam generator” in this example.

Referring to FIG. 29, the fluid discharge piping network 248 comprises each heat exchanger having associated fluid outlet piping 212-2 fluidly coupled to its respective fluid outlet 212 on one top header 201 at one end, and a piping manifold 253 at the other end. Outlet piping 212-2 is shown in dashed lines for convenience to be visually distinguishable from the discharge piping 212-2. At least one fluid outlet valve 212-1 is installed in and fluidly coupled in the fluid outlet piping 212-2 of each heat exchanger as shown. The heated heat transfer fluid (e.g., steam) discharged from each heat exchangers may be fluidly isolated from the other heat exchangers via selectively closing one or more fluid outlet valves 212-1 associated with each heat exchanger. Manifold 253 collects and combines the heated heat transfer fluid (steam in this example) from each heat exchanger 200 into a single discharge stream which can flow to the closed flow loop 110 of the systems shown in FIG. 1B or 1C (or others). Any suitable piping diameter and metallic material may be used to form manifold 253 as needed. Manifold 253 may be formed of stainless steel in one embodiment for corrosion resistance. Any suitable field routing of fluid outlet piping 212-2 may be used as convenient to allow proper support of the piping from the TES vessel 130. It bears noting that other discharge piping arrangements and valving may be used other than the manifold to combine the discharges from each heat exchanger while still allowing the discharge side of the heat exchangers to be fluidly isolated from each other to support independent operation of each exchanger.

One non-limiting example of a fluid inlet piping network 249 having a configuration allowing selective isolation of each heat exchanger 200 on the inlet side is also shown schematically in FIG. 29. On the fluid inlet side of the heat exchangers 200, a multi-branched network of fluid inlet piping 219-2 is provided which divides a single return stream of cool heat transfer fluid from the closed flow loop shown in FIG. 1B or 1C (or other steam applications) into multiple streams flowing to the return fluid inlets 219 associated with each heat exchanger 200. Selectively closing one or more return inlet valves 219-1 in the fluid inlet piping 219-2 of each heat exchanger (see also FIG. 22 previously described herein) may be used to fluidly isolate each the heat exchanger on the inlet side from the other heat exchangers. Because the tube bundles 210 of each heat exchanger are already isolated from each other within the internal cavity 135 of TES vessel 130 as previously described herein, selectively closing the foregoing inlet and outlet valves 219-1, 212-1 external to TES vessel 130 allows each heat exchanger 200 to operate fully independently of the other heat exchangers, thereby advantageously providing considerable operating flexibility to meet varying demands for heated heat transfer fluid such as steam in the illustrated embodiment.

With continuing reference to FIG. 29, for steam service, piping manifold 253 in turn may be fluidly coupled on the downstream side to a steam reservoir 250 via manifold discharge piping 251-1 under control of a manifold discharge valve 251 therein (changeable between open and closed positions). The discharge from the steam reservoir pressure vessel is fluidly coupled to the intended downstream steam application system via reservoir discharge piping 252-1 under control of reservoir discharge valve 252. The steam application system may be the closed flow loops 110 of the systems shown in FIG. 1B or 1C in some embodiments previously described herein, or other applications. The steam reservoir 250 may comprise a pressure vessel 250-1 including an elongated and cylindrical steel outer shell 250-2 in some configurations which defines an open internal volume sized to hold the desired volume of steam produced by the heat exchangers 200 to suit the needs of the particular end use application. Pressure vessel 250-1 may be horizontally or vertically oriented. The pressure vessel is preferably located proximate to TES vessel 130 and can be used to collect and store the steam produced by the TES vessel until required. If the use is continuous, the steam may simply flow directly through the vessel in a continuous manner without temporary retention or storage. Even if used for continuous operation, the steam reservoir 250 provides a buffer for equilibrating the pressure of steam received from each of the heat exchangers 200 before flowing to the downstream end use application.

The steam reservoir pressure vessel 250-1 and foregoing fluid outlet piping 212-2, reservoir discharge piping 252-1, and manifold discharge piping 251-1 may be heavily insulated to prevent an undue amount of steam from condensing before its end use.

It bears noting that in certain embodiments, the manifold 253 may be omitted and the fluid outlet piping 212-2 of the fluid discharge piping network 248 may configured so that the fluid discharge from each heat exchanger 200 may be fluidly coupled directly to the steam reservoir 250 independently of the other heat exchangers. In this case, the steam reservoir acts to collect and combine the heated heat transfer fluid discharge (e.g., steam) from each heat exchanger separately.

It also bears noting that the same heat exchanger inlet and outlet piping networks 248, 249 including pipe manifold 250 shown in FIG. 29 and described above which is configured to fluidly isolate each heat exchanger 200 on the tube-side from others may be used for handling heated heat transfer fluid in a liquid state in lieu of steam. The steam reservoir pressure vessel may be eliminated, or alternatively a similar vessel may be used to store the heated liquid (e.g., water or other) until needed by the end use application.

Returning back now to the heat exchangers 200 and general reference to FIGS. 1-28 as applicable, the tube bundles 210 of each heat exchanger which define the active heat transfer region of each heat exchanger may be arranged in a straight once-through flow pattern on the tube-side through the thermal mass composition which is a stationary or “captive” mass that does not flow into or out of TES vessel 130 (see particularly FIG. 22 flow schematic). The heated heat transfer fluid (e.g., liquid or steam phase) discharged by each heat exchanger may be fluidly coupled and piped together after leaving each heat exchanger top header 201 to form a single stream of heated fluid for district heating, power generation, or other uses.

It bears noting that the thermal mass composition M is a non-flowing and stationary/captive mass inside TES vessel 130 which is not pressurized since internal cavity 135 of the TES vessel is at atmospheric pressure. The tubes 211 of the tube bundles 210 therefore form the pressure boundary of the heat transfer fluid flowing therein which is put under pressure from being heated by the thermal mass composition.

To provide access to the top and bottom headers 201, 203 of each heat exchanger 200, at least one manway 240 is provided for each header. The manway comprises an openable/closeable hatch 241 hingedly coupled to the vertical shells of the headers 201, 203. The hatches are configured to fluidly seal the access openings to the headers via inclusion of appropriate gasketing material. Because it is not uncommon for heat exchanger tubes to develop cracks and leak over time due to temperature and pressure cycling, manway 240 allows workers to readily access the top or bottom tubesheets 202, 204 for maintenance such as plugging any leaking tubes at the tubesheets and/or for routine inspection of the tubesheets for tube ligament cracking.

TES vessel 130 further comprise a plurality of fill ports 245 at top extending through top closure plate 136. The fill ports allow thermal mass composition M to be added to internal cavity 135 of the vessel. In one embodiment, four fill ports may be provided; one each being located in each top corner of the vessel see, e.g., FIG. 5). Each fill port may comprise aa short section of capped piping as shown which is in fluid communication with internal cavity 135 of the vessel 130.

It bears particular note that internal cavity 135 of the TES vessel 130 defines a common space or volume shared by the tube bundles 210 of all heat exchangers 200. The outer surfaces of the heat transfer tubes 211 of each heat exchanger are therefore in direct physical and conformal contact with the same undivided/unsegregated bed of thermal mass composition M in the cavity 135. Advantageously, this ensures uniform heating of the heat transfer fluid flowing through the tube-side of each heat exchanger 200 by a single thermal mass. Accordingly, there are no physical partitions or dividers which sub-divide the vessel internal cavity 135, thereby which further reduces fabrication costs. By contrast, the tube-sides of the heat exchangers are fluidly isolated from each other as described elsewhere herein.

The components of the heat exchangers 200 including the top and bottom headers 202, 204 and tubes 211 have a fully metallic construction. These components are preferably formed of steel, and more preferably a suitable corrosion resistant metal such as stainless steel for at least the wetted parts thereof. Other types of tubing materials however may be used. The appropriate type of tube material can be selected for compatibility and use with the particular type of thermal mass composition M used so as to not be corrosively affected by the chemistry of at least the phase change constituent of the material. Other metallic materials may be used for the heat exchangers components as appropriate for the particular application.

TES vessel 130 further comprises an array of immersion heaters 150 embedded in the thermal mass composition M held inside internal cavity 135 of the vessel (see, e.g., FIGS. 5, 17-19, and 25). The heaters may be electric in one non-limiting embodiment which are configured for electrical coupling to an available source of electricity such as via any suitable commercially-available electric contacts or connectors necessary for the intended application. The electric power source may be the regional electric power grid controlled by public utilities, and/or an on-site local power source such as that at an electric power generation plant which may utilize renewable energy sources (solar, wind, biomass, etc.) or nuclear power to generate electricity. The heaters 150 convert electric power received from the electric power source (whatever its nature) to thermal energy which is used to heat the thermal mass composition.

In other embodiments, in lieu of electric powered heaters, the heaters 150 may each be configured as tubed heat exchangers which circulate a second heat transfer fluid through heat exchanger tubes embedded in the thermal mass composition M of TES vessel 130 in the same location and with the same insertable/retrievable sliding unit construction as the electric heaters shown. The second heat transfer fluid may be comprise a liquid such as water, glycol, liquid salt, or other heat transfer fluid. The

In one embodiment, the heaters 150 may each have a modular construction comprising a panel or box-shaped heater housing 151 and plurality of horizontally elongated heating elements 170 mounted to the housing. Housing 151 is configured to support the heating elements and forms a self-supporting heater which may be handled and installed/removed as a single unit. In one embodiment, housing 151 may include a plurality of horizontally spaced apart heating element support plates 151-2 with holes formed in each plate to receive and support the horizontally-extending elongated elements (see, e.g., FIG. 20). Housing 151 may have a rectangular cuboid configuration in one embodiment as shown; however, other shaped polygonal or non-polygonal (e.g., cylindrical) heater housings may be provided. Heating elements 170 may be horizontally oriented and rod-shaped. The elements are each in direct physical contact with the thermal mass composition M internal cavity 135 of TES vessel 130. The heating elements may have a cylindrical configuration in one non-limiting embodiment.

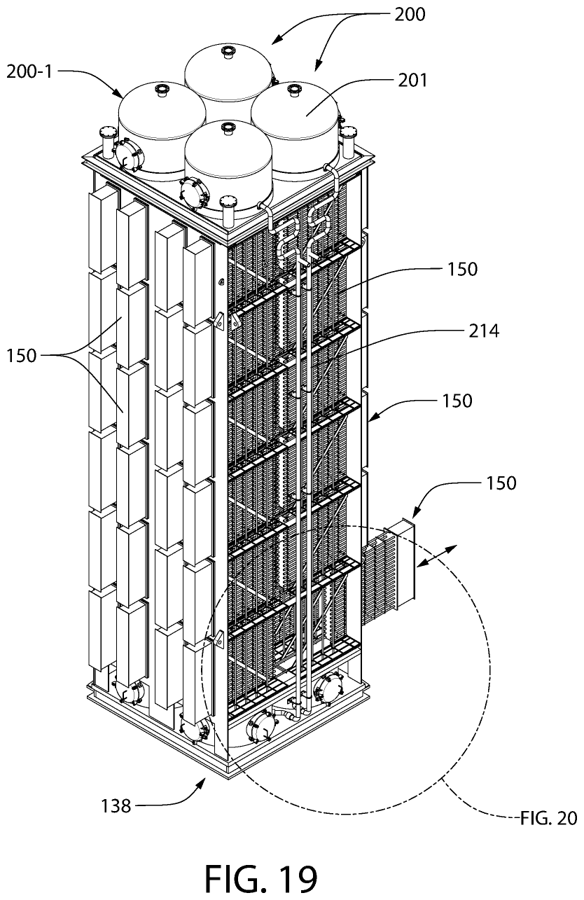

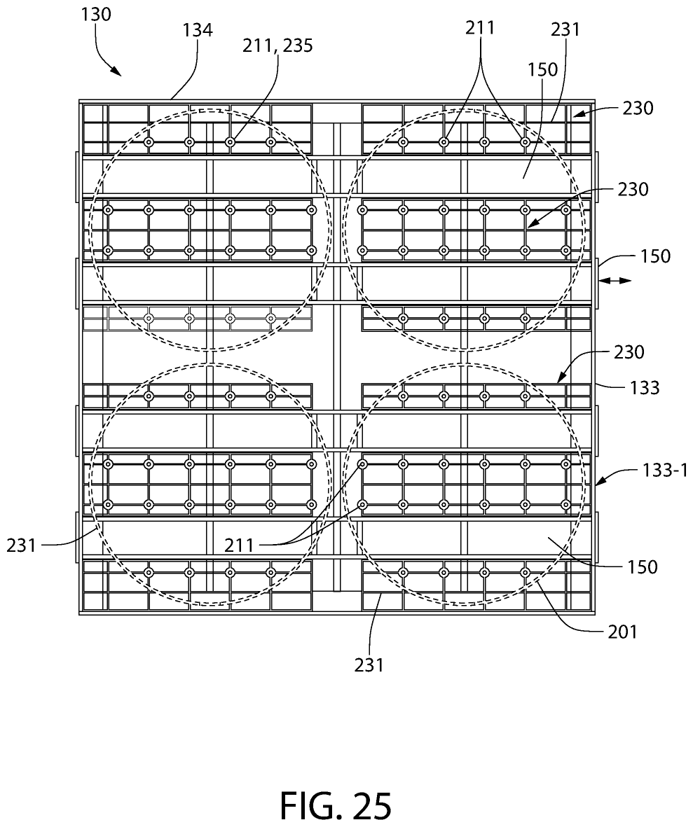

Heaters 150 are removably and slideably insertable in a horizontal direction into TES vessel internal cavity 135 between the vertical heat exchanger tubes 211 of the tube bundles 210 of each heat exchanger 200 (see, e.g., FIGS. 19-21 and 25). In one non-limiting arrangement, banks of heaters 150 may be provided on two opposing sidewalls 133 of TES vessel 130. The units 150 are vertically and horizontally spaced apart from each other on each sidewall as shown. A sufficient number of heaters 150 are provided which are located over substantially the entire height of TES vessel internal cavity 135 and the bed of thermal mass composition M contained therein to evenly heat the bed of material from top to bottom. In one implementation, each heater 150 may have a horizontal width which extends for greater than 40% the width of the TES vessel housing 134 measured between the opposing sidewalls 133. Accordingly, each heater 150 has a width slightly less than half the width of the vessel housing, and preferably no less than the horizontal/lateral extent of each heat exchanger tube bundle 210 to ensure the thermal mass composition adjacent each heat exchanger tube 211 of the bundle is adequately heated by the heating elements 152 of the heaters (see, e.g., FIG. 25).

As shown, pairs of heaters 150 may be arranged in opposing end-to-end relationship at each elevation of the vessel 130 where heaters are located; each unit entering from one of the two opposing vessel sidewalls 133. Any suitable number of heaters 150 may be provided to sufficiently heat thermal mass composition M to its desired max temperature Tmax, which in turn determines the max temperature to which the heat transfer fluid can be heated flowing through the heat exchanger tubes 211 embedded in the thermal mass.

The heaters 150 may be detachably coupled to the side plates 133-1 of the opposing TES vessel sidewalls by any suitable fastening means including for example without limitation welding, threaded fasteners, or other approached. Complementary configured mounting holes 153 best shown in FIG. 21 are provided in TES vessel housing 134 (i.e. side plates 133-1 of sidewalls 133) to allow the elongated heating elements 152 of heaters 150 to slide into and enter internal cavity 135 of the vessel for embedment into the thermal mass composition. The thermal mass composition M may be added to the vessel internal cavity after heaters 150 are installed at each elevation from the bottom to the top of the vessel in stages. Other manners of installing the heaters and thermal mass composition may be used. A relatively tight interface may preferably be provided between the vessel housing mounting holes 153 and outermost exposed portions of the heater housings 151 which protrude laterally/horizontally outward from the sidewalls 133 of TES vessel 130. The exposed portion of each heater housing 151 comprises a weather-proof junction box 151-1 which therein may contain conventional electrical wiring connectors (not shown) for electrically coupling the heaters to the electric power source.

When the heaters are installed in the thermal energy storage vessel 130, the thermal mass composition comprised of generally granular solid particles when unheated fills the voids between the heating elements 152 and the heat exchanger tubes 211 before the elements are energized. When the heating elements are energized, the heretofore granular solid phase change material (PCM) particles melt and are converted to a flowable liquid or molten state which fills the interstitial spaces between the non-melting constituents of the thermal mass composition (i.e. metallic material as further described herein). The thermal mass composition is in direct conformal contact with the heating elements 152 and tubes 211 for maximum heat transfer to the heat transfer fluid flowing inside the tubes 211 of the heat exchangers 200.

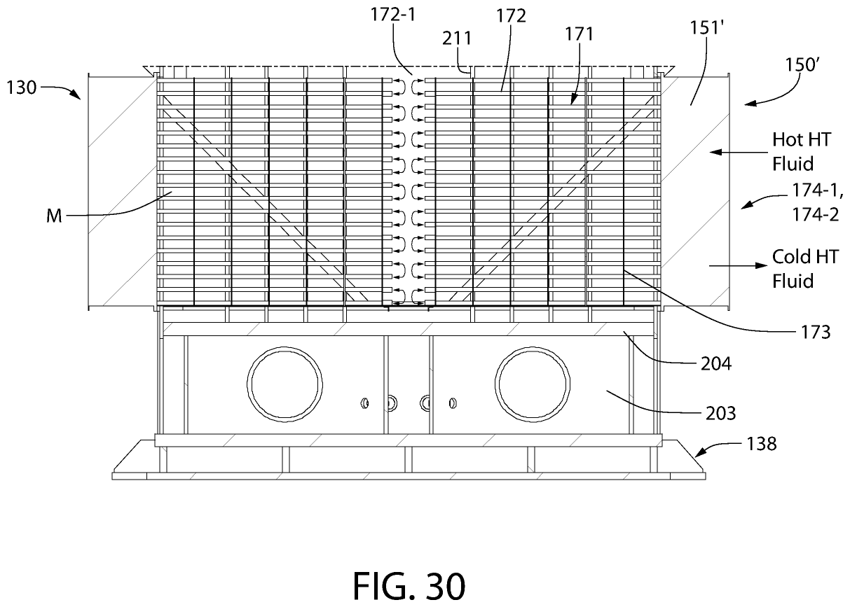

In other embodiments, in lieu of electric powered heaters, the heaters 150 may each be configured as a modular tubed immersion heat exchanger unit 150′ which circulates a second heat transfer fluid through heat exchanger tubes 152′ embedded in the thermal mass composition M of TES vessel 130 in the same locations and with the same insertable/retrievable sliding unit construction as the electric heaters shown. FIG. 30 depicts immersion heat exchanger units 150′, which are arranged in banks of heaters on opposing sides of the TES vessel housing similarly to the electric heaters as previously described herein. The second heat transfer fluid may comprise any suitable flowable liquid such as water, glycol, molten/liquid salt, heat transfer oil, or other which is used to heat thermal mass composition. The second heat transfer fluid may be heated via solar energy in a solar collector in some embodiment as previously described herein and circulate in a flow loop between the collector and TES vessel. In yet some other embodiments, steam may flow on the interior tube-side of the heat exchanger tubes 152′ from a steam generator using any type fuel to convert water to steam.

The immersion heat exchanger units 150′ may each have the same type modular construction as the electric heaters which can be slid into and out of TES vessel 130 in a similar manner to that shown in FIG. 20 for the electric heaters. This allows heat exchanger units to be quickly swapped out for maintenance in the case of tube leaks and replaced with a new unit, thereby advantageously minimizing any downtime of the TES vessel for heating the heat transfer fluid. Each heat exchanger unit 150′ may similarly comprise a rectilinear panel or box-shaped heater housing 151′ and includes a tube bundle 171 comprising a plurality of horizontally elongated heat exchanger tubes 172 mounted to the housing and embedded in the thermal mass composition. Accordingly, the tubes of the tube bundle are directly exposed to and in direct intimate contact with the thermal mass composition inside TES vessel 130 (i.e. no intervening outer metal shell as in shell and tube type heat exchangers). In other possible embodiments, horizontally elongated cylindrical heat exchanger housings may be used. Housing 151′ is configured to support the tubes in a manner which forms a self-supporting heater which may be handled and installed/removed as a single unit.

In one embodiment, with continuing reference to FIG. 30, heat exchanger housing 151′ may include a plurality of horizontally spaced apart tube support plates 173 with holes formed in each plate to receive and support the tubes. The tubes 172 may be U-shaped in some embodiments comprising a plurality of U-shaped tube bends 172-1 which return the second heat transfer fluid back to a heat exchanger channel box 174 which replaces the external weather-proof junction box 151-1 of the electric heaters. Channel box 174 is internally configured to form an inlet flow plenum 174-1 to distribute hot heat transfer fluid to the tubes for heating the thermal mass composition M in TES vessel 130, and an outlet flow plenum 174-2 configured to receive the cold heat transfer fluid after yielding its heat from the tubes to the thermal mass. A suitable conventional divided heat exchanger channel box which is typically used in the heat exchanger arts in combination with U-bend tube bundles may be used and needs no further description to those skilled in the art.

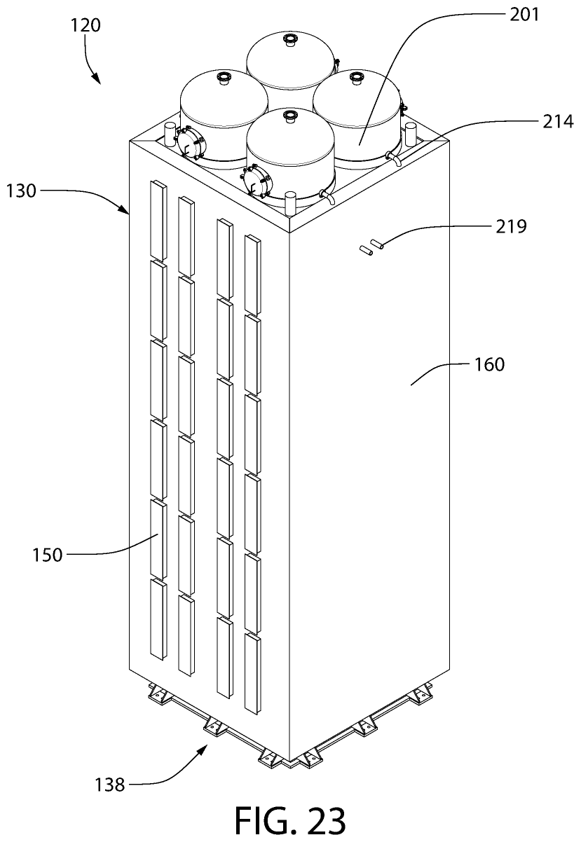

To retain the heat of the thermal mass composition M inside TES vessel 130, the housing 134 is heavily insulated. FIG. 23 shows the TES vessel in an insulated state comprising an outer layer of insulation 160 wrapped around the sidewalls 133 of the vessel. Other portions of the vessel may be insulated as needed (e.g., exposed portions of the top plate, etc.).

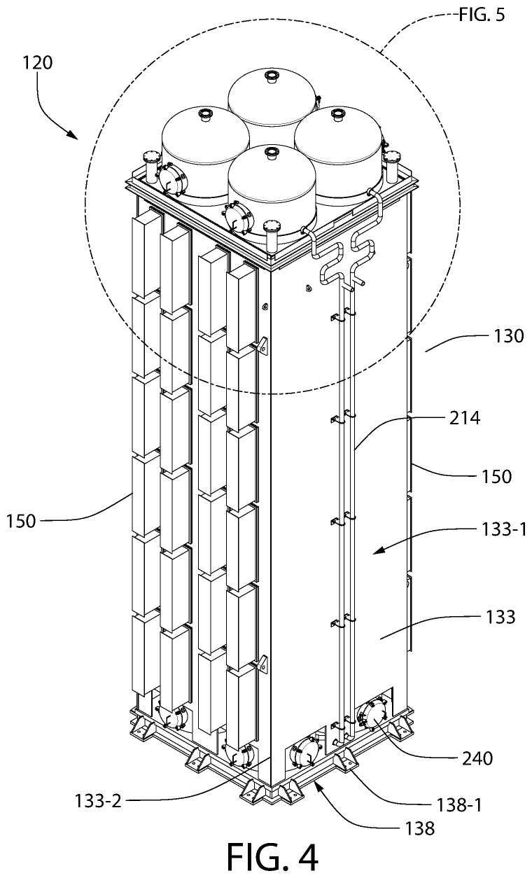

Note that the downcomer piping 214 shown previously such as in FIGS. 4-5 (and others) is no longer visible in FIG. 23 and buried beneath the insulation 160 to retain heat in the heat transfer fluid flowing being recirculated through the downcomers from the top headers 201 to bottom headers 203. Any suitable type of commercially-available insulation and thickness may be used as appropriate for this application. It is well within the ambit of those skilled in the art to choose a suitable type and thickness of insulation. Commercially-available corrugated metal siding panels (not shown) may also be applied over the insulation 160 for protection against the elements to maintain the integrity of the insulation.

Thermal mass composition M will now be further described.

Any suitable thermal mass composition M may be used which can be customized and selected for the required thermal duty and operating parameters needed for heating the heat transfer fluid (which may be water/water mixtures or other fluids) from an inlet temperature entering the TES (thermal energy storage) vessel 130 to a desired outlet temperature. In one embodiment, without limitation, the thermal mass composition may be a mixture comprising at least one first base metallic material mixed with a second phase change material (PCM). Both the base metallic material(s) and PCM of the thermal mass composition mixture may be in a granular particle form (i.e. a solid) at ambient temperatures which is flowable to fill internal cavity 135 of the TES vessel via openable/closeable fill ports 245 (see, e.g., FIG. 5) through the vessel housing 134. Both the base metallic material(s) and PCM are materials having properties configured to produce a thermal mass operable to absorb and store heat, and release that heat on demand when required to heat the heat transfer fluid flowing through tubes 211 of the tube bundles 210 in each heat exchanger 200.

Preferably, the at least one base metallic material may constitute a majority of the mixture or composition and has a higher melting point or temperature Tbm than the melting point or temperature Tpcm of the PCM. Temperature Tpcm is preferably lower than the normal operating temperature Tnm of the thermal mass composition M to which the mass will be heated for normal operation (via the heat or thermal energy supplied by heaters 150) such that the PCM melts and changes to a liquid or molten state when the thermal mass is heated. At ambient temperatures, the PCM is in a solid particle state.

By contrast, the at least one base metallic material preferably has a melting temperature Tbm greater than the normal operating temperature Tmm, and preferably greater than the maximum temperature Tmax of the thermal mass composition when heated by the heaters such that the base metallic material always remains in a solid particle state whether the heaters are fully energized or offline. In some representative but non-limiting examples, the base metallic material may have a melting temperature Tbm greater than 1,000 degrees C. (Celsius), or greater than 2,000 degrees C. in some embodiment, whereas the PCM may have a melting temperature Tpcm less than 1,000 degrees C. The metallic material may comprise a single one or a combination of ferrous and/or non-ferrous metal particles selected to optimize heat retention capabilities and meeting the foregoing melting temperature criteria.

In use to store thermal energy, the TES vessel 130 (i.e. internal cavity 135) is first filled with the thermal mass composition M to a final elevation or level that at least covers the highest or uppermost heaters 150 in the vessel. Both the at least one base metallic material and PCM are in a solid granular particle state at ambient temperatures before the thermal mass is heated by electric heaters 150. The initially “off” heaters 150 are then energized, which heats the entire bed of thermal mass composition M to its normal operating temperature Tnm (which may be less than its maximum temperature Tmax in some cases). While the at least one base metallic material remains in solid granular particle form, the PCM will melt thereby flowing and filling the interstitial spaces/voids between the base metallic material particles. This advantageously results in more efficient and complete heating of the thermal mass composition M than if all metallic material were used because air-filled pockets or voids between the material particles is filled with a conductive liquid PCM, thereby increasing the heat retention properties of the thermal mass. Thought of another way, this might be considered somewhat analogous to wetted sand in which water fills voids between the sand particles. The melted PCM in combination with the still solid base metallic material particles further allows the thermal mass composition mixture to enhance conformal contact with both the heating elements 152 of heaters 150 and the outer surfaces of the heat transfer tubes 211 of each heat exchanger 200 which further benefits heat transfer. When the heat input is removed from the thermal mass composition by de-energizing the heaters 150, the PCM will return to a solid state.

In preferred but non-limiting embodiments, the PCM used may be a salt which may be converted from a granular solid particle state at ambient temperatures to a liquid/molten state when heated by electric immersion heaters 150 when energized by electric power extracted from an available power source such as the electric power grid or another source. Any suitable salt may be used which is selected for the required thermal duty.

Some examples of salts which may be used to form the PCM bed B in each thermal energy storage vessel 121 are shown in the following table:

| Tₘₑₗₜ | | Latent Heat |
|---|---|---|
| (° C.) | Material | (kJ/kg) |
| 94 | 60 wt % AlCl₃ + 14% KCl + 26% NaCl | 213 |
| 150 | 66 wt % AlCl₃ + 34% NaCl | 201 |
| 202 | 7.5 wt % NaCl + 23.9% KCl + 68.6% ZnCl₂ | 200 |
| 258 | 59 wt % NaOH + 41% NaNO₃ | 292 |
| 307 | NaNO₃ | 177 |
| 318 | 77.2 mol% NaOH − 16.2% NaCl − 6.6% Na₂CO₃ | 290 |
| 320 | 54.2 mol % LiCl − 6.4% BaCl₂ − 39.4% KCl | 170 |
| 335 | KNO₃ | 88 |
| 340 | 52 wt % Zn − 48% Mg | 180 |
| 348 | 58 mol % LiCl − 42% KCl | 170 |
| 370 | 26.8% NaCl − 73.2% NaOH | 320 |
| 380 | KOH | 149.7 |
| 380 | 45.4 mol% MgCl₂ − 21.6% KCl − 33% NaCl | 284 |
| 381 | 96 wt % Zn − 4% Al | 138 |
| 397 | 37 wt % Na₂CO₃ − 35% K₂CO₃ − 31% Li₂CO₃ | 275 |
| 430 | 56 wt % NaCl − 44% MgCl₂ | 168 |
| 443 | 59 wt % Al − 35% Mg − 6% Zn | 310 |
| 450 | 48 wt % NaCl − 52% MgCl₂ | 430 |
| 470 | 36 wt % KCl − 64% MgCl₂ | 388 |
| 487 | 56 wt % Na₂CO₃ − 44% Li₂CO₃ | 368 |
| 500 | 33 wt % NaCl − 67% CaCl₂ | 281 |
| 550 | LiBr | 203 |
| 632 | 46 wt % LiF − 44% NaF₂ − 10% MgF₂ | 858 |
| 658 | 44.5 wt % NaCl − 55.5% KCl | 388 |
| 714 | MgCl₂ | 452 |
| 801 | NaCl | 510 |

The melt temperatures and latent heat properties of the salt are properties and factors which direct the selection of the type salt for the required thermal duty and temperature increase of the heat transfer fluid. It bears noting that the type of salt used in each thermal energy storage vessel 130 for the Green Boiler 120 may therefore be customized and different. Regardless of the application including simply heating water for district heating or other applications, it is apparent to those skilled in the art that thermal duty and performance of the thermal energy storage vessel 121 is highly customizable to meet the required temperature increase objectives of the thermal energy system.

It bears noting that any suitable PCM may be used other than the salts such as those listed above may be used so long as the melting temperature Tpcm of the PCM is less than the normal operating temperature Tnm (previously described herein) of the thermal mass composition during operation of the TES vessel 130 when the heaters 150 are energized.

Although the thermal energy storage (TES) vessel 130 121 disclosed herein may have been described without limitation for heating water to either a hot liquid phase or a steam phase for various purposes and applications via the thermal mass composition bed, the invention is not limited in this regard. Accordingly, the TES vessels 130 may be used to heat any and other type of fluid which are flowable through the heat exchanger tubes 211 of the vessel. Accordingly, numerous applications of the “green” thermal energy storage system 100 are possible and within the scope of the present disclosure.

General operation of the TES vessel 130 to store thermal energy and heat a heat transfer fluid may be summarized as follows. The process or method may begin with the thermal mass composition M being depleted of sufficient thermal energy to heat the heat transfer fluid to the desired operating conditions (e.g., pressure and temperature). This may result from operating and discharging the thermal energy from the thermal mass, or before operating the TES vessel 130 after a period of time or upon initial startup. TES vessel 130 may be fluidly isolated at this point from the closed flow loop 110 (see, e.g., FIG. 1B or 1C) via closing inlet valve 219 and outlet valve 212-1 shown in FIG. 22.

Next, the banks of electric immersion heaters 150 are then energized by drawing electric power from the utility electric power grid (or other source) preferably during off-peak demand periods of the grid when energy costs are lowest if possible, or another source of electricity. Power is input to the heaters until the thermal mass composition M is heated to its normal operating temperature Tnm temperature and optimum heat retention capacity. Power is then terminated from the power source. The thermal mass composition is now fully thermally charged and in a standby condition ready for operation when needed for producing steam or hot water (or other heated heat transfer fluid) when the thermal energy systems of FIG. 1B or 1C demand During this standby period, the heat transfer fluid may be recirculated through the heat exchanger tube bundles 210 and TES vessel 130 via the downcomer piping 214 which forms the vessel circulation flow loop.

When it is desired to start operation of the TES vessel 130, the inlet and outlet valves 219-1, 212-1 are then opened. This initiates the flow of the heat transfer fluid from closed flow loop 110 through the vessel and bed of thermal mass composition inside the tubes 211 of the one or more heat exchangers 200. The heat transfer fluid is heated to operating temperature and pressures by the thermal energy released from the thermal mass composition as described elsewhere herein. It bears noting that if steam is being produced, the steam may be generated by TES vessel 130 at saturated conditions for lower pressure steam applications (e.g., industrial uses or steam heating), or superheated conditions for power generation via the Rankine cycle system shown in FIG. 1B. The heat transfer surface area of the tubes 211 in the heat exchanger tube bundles 210 and composition of the thermal mass composition can be designed and customized to provide the necessary heating of the heat transfer fluid to the desired operating temperatures and pressures.

Once the usable thermal energy stored in the thermal mass composition is depleted, or alternatively end use demand no longer requires operation of TES vessel 130 and heating of the heat transfer fluid, the inlet and outlet valves 219-1, 212-1 of the vessel may be reclosed. The foregoing operating cycle may be repeated as often as needed based on demand for steam or heated liquid heat transfer fluid (e.g., water or other heat transfer medium).

The present thermal energy storage system 100 is advantageously modular in nature. In other words, multiple thermal energy storage (TES) vessels 130 may be provided for any given installation to meet the design and operational requirements of the facility utilizing them to heat a heat transfer fluid via the thermal energy stored in the thermal mass composition M inside each vessel. Potential applications for the system include the production of hot water (or water mixtures such as glycol and water) for district heating, industrial processes, or other heated liquid uses, and the generation of steam for steam heating, industrial processes, electric power generation, or other uses. The number of TES vessels 130 deployed is selected to produce a heat transfer fluid be it in liquid or gaseous (e.g., steam) state of sufficient volume/amount and temperature to meet the intended application needs. In addition, extra heat transfer fluid heating capacity may be added over time with the present modular system as demand grows such as for example without limitation increases in population and infrastructure (e.g., housing, etc.) in a district heating or other application.

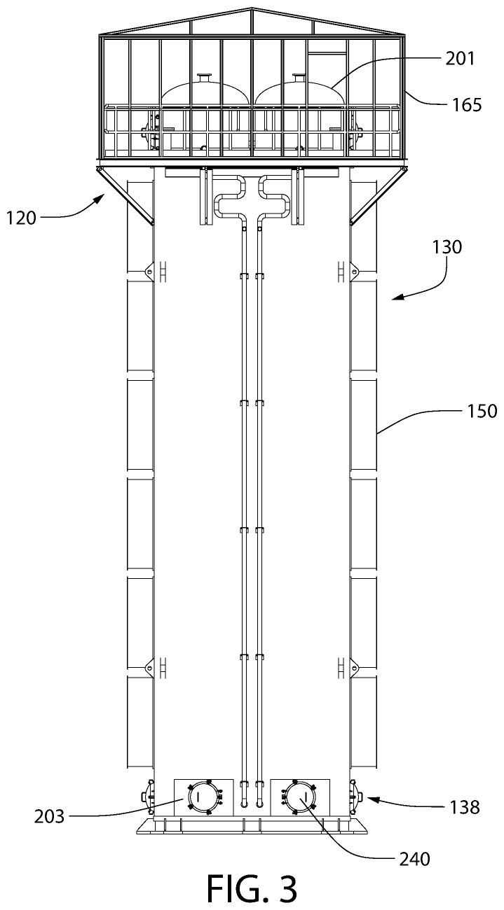

To facilitate maintenance of the heat exchangers 200 of the green boiler 120, the TES vessel 130 may further comprise a penthouse structure 165 shown only in FIGS. 2 and 3. Only the structural framework of the penthouse structure is shown to better show and reveal the top headers 201 of the heat exchangers 200. The penthouse structure would include convention metal siding, roof panels, and optionally insulation to enclose the space within, thereby protecting operators and maintenance works from the elements during inclement weather conditions. The top headers can be accessed via the manways 240 previously described herein.

A method or process for heating a heat transfer fluid using green boiler 120 will now be described and summarized. The method includes providing the thermal energy storage vessel 130 containing thermal mass composition M comprising a mixture of a metallic material and a phase change material each initially in the form of solid particles. The metallic material has a higher melting temperature than the phase change material. The method continues with heating the thermal mass composition to a temperature which melts the phase change material, with the metallic material however remaining as solid particles. The method continues with storing the heat in the thermal mass composition. The method continues with circulating a heat transfer fluid through the thermal mass composition, and heating the heat transfer fluid. The heating step may include energizing a plurality of electric heaters embedded in the thermal mass composition. The circulating step may include flowing the heat transfer fluid through a tube bundle embedded in the thermal mass composition. The tube bundle may be part of at least one heat exchanger 200 incorporated into the thermal energy storage vessel. The heated heat transfer fluid may be in liquid or steam form. The heating step may further include the melted phase change material flowing and filling interstitial spaces between the solid particles of the metallic material.

### Summary of the Example Claims

Following are example claims for the invention described herein which find support in the present disclosure.

Example claim 1: A green boiler comprising: a thermal energy storage vessel defining an internal space containing a thermal mass composition operable to store thermal energy, the thermal mass composition comprising a metallic material and a phase change material; at least one heater embedded in the thermal mass composition, the at least one heater configured and operable to heat the thermal mass composition; and at least one heat exchanger comprising a tube bundle including a plurality of heat exchanger tubes embedded in the thermal mass composition, the heat exchanger tubes configured to convey a heat transfer fluid through the thermal mass composition which heats the heat transfer fluid.

Example claim 2: The boiler according to example claim 1, wherein the thermal energy storage vessel and the at least one heater are physically integrated into a single self-supporting housing.

Example claim 3: The boiler according to example claim 2, wherein the housing comprises a top closure plate, a bottom closure plate, and a plurality of sidewalls extending therebetween.

Example claim 4: The boiler according to example claim 2, wherein the housing comprises a support base configured for placement on a flat concrete foundation slab.

Example claim 5: The boiler according to any one of example claims 2-4, wherein the housing is vertically elongated and has a rectangular cuboid configuration.

Example claim 6: The boiler according to example claim 3, wherein the heat exchanger comprises a top header supported on the top closure plate and defining a top flow plenum, and a bottom header supported on the bottom closure plate and defining a bottom flow plenum, the top and bottom flow plenums being in fluid communication with the heat exchanger tubes inside the housing.

Example claim 7: The boiler according to example claim 6, wherein the heat exchanger further comprises a top tubesheet supported on the top closure plate inside the top flow plenum, and a bottom tubesheet supported on the bottom closure plate inside the bottom flow plenum.

Example claim 8: The boiler according to example claim 7, wherein top ends of the tubes are coupled to and extend through the top tubesheet, and bottom ends of the heat exchanger tubes are coupled to and extend through the bottom tubesheet.

Example claim 9: The boiler according to example claim 8, wherein the top tubesheet further comprises a plurality of upwardly protruding extension tubes, each extension tube being fluidly coupled to and associated with a respective one of the heat exchanger tubes.

Example claim 10: The boiler according to example claim 9, wherein top ends of the extension tubes terminate at an elevation greater than a surface level of a condensate pool P formed in the top flow plenum inside the top header.

Example claim 11: The boiler according to example claim 8, wherein the housing further comprises an annular thermal expansion sleeve fixedly coupled to the top closure plate, the sleeve circumferentially surrounding the top sheet and a lower portion of top header which are slideably disposed inside the sleeve.

Example claim 12: The boiler according to example claim 11, wherein when the heat exchanger tubes are heated and expand in length, the top sheet and top header move upwards with the top ends of the heat exchanger tubes relative to the top closure plate which remains stationary.

Example claim 13: The boiler according to any one of example claims 6-12, wherein the top flow plenum is fluidly coupled to the bottom flow plenum by a vertical downcomer located outside the housing.

Example claim 14: The boiler according to example claim 13, wherein the heat transfer fluid recirculates between the top flow plenum and the bottom flow plenum via the downcomer through convective thermo-siphon effect without the assistance of a pump.

Example claim 15: The boiler according to example claim 3, wherein the at least one heater comprises a plurality of heaters each comprising horizontally elongated electric heating elements which extend into the thermal mass composition in the vessel.

Example claim 16: The boiler according to example claim 15, wherein the heaters are removably coupled to an opposing pair of the sidewalls of the housing, the heaters being slideably insertable into and retractable from the internal cavity of the vessel in a horizontal direction.

Example claim 17: The boiler according to example claim 1, wherein the heat transfer fluid comprises water.

Example claim 18: The boiler according to example claim 17, wherein the vessel is configured to convert the water from a liquid state entering the vessel to steam exiting the vessel.

Example claim 19: The boiler according to example claim 17, wherein the vessel is configured to receive the water in a liquid state at a first temperature and discharge the water in a liquid state at a second temperature higher than the first temperature.

Example claim 20: The boiler according to any one of example claims 1-19, wherein the thermal mass composition comprises a mixture of a metallic material and a phase change material each in the form of solid particles at ambient temperature.

Example claim 21: The boiler according to example claim 20, wherein the metallic material has a higher melting temperature than the phase change material.

Example 22: The boiler according to example 3, wherein the at least one heater comprises horizontally elongated heat exchanger tubes which extend into the thermal mass composition in the vessel, the heat exchanger tubes flowing a heated second heat transfer fluid through the tubes which heats the thermal mass composition.

Example 23: The boiler according to example 22, wherein the heaters are removably coupled to an opposing pair of the sidewalls of the housing, the heaters being slideably insertable into and retractable from the internal cavity of the vessel in a horizontal direction.

Example claim 24: A method for heating a heat transfer fluid via thermal energy storage comprising: providing a thermal energy storage vessel containing a thermal mass composition comprising a mixture of a metallic material and a phase change material each in the form of solid particles, the metallic material having a higher melting temperature than the phase change material; heating the thermal mass composition to a temperature between the melting temperatures of the metallic material and the phase change material, thereby melting the phase change material while the metallic material remains in the solid state; storing the heat in the thermal mass composition; circulating a cool heat transfer fluid through the thermal mass composition; and the heat transfer fluid extracting heat from the thermal mass composition which heats the heat transfer fluid.

Example claim 25: The method according to example claim 24, wherein the heating step includes energizing a plurality of electric heaters embedded in the thermal mass composition.

Example claim 26: The method according to example claim 24 or 25, wherein the phase change material is a salt.

Example claim 27: The method according to example claim 26, wherein the heating step includes the melted phase change material flowing and filling interstitial spaces between the solid particles of the metallic material.

Example claim 28: The method according to example claim 24 or 25, wherein the heated heat transfer fluid is heated water in liquid form.

Example claim 29: The method according to example claim 28, further comprising flowing the heated water through a district heating flow distribution network.

Example claim 30: The method according to example claim 24 or 25, wherein the heated heat transfer fluid is water in steam form.

Example claim 31: The method according to example claim 30, further comprising flowing the steam through a turbine-generator set configured to generate electricity.

Example claim 32: The method according to example claim 24 or 25, wherein the circulating step includes flowing the heat transfer fluid through a tube bundle embedded in the thermal mass composition.

Example claim 33: The method according to example claim 32, wherein the tube bundle is part of a heat exchanger.

Example claim 34: The method according to any one of example claims 24-33, further comprising recirculating and mixing a portion of the heated heat transfer fluid which is exiting the vessel with the cool heat transfer fluid which is entering the vessel.

Example claim 35: The method according to any one of example claims 24-34, wherein the vessel is vertically elongated and comprises a top flow plenum which receives the heated heat transfer fluid from the tube bundle, and a bottom flow plenum which receives the cool heat transfer fluid before it enters the tube bundle.

Example claim 36: The method according to example claim 35, further comprising recirculating a portion of the heated heat transfer fluid extracted from the top flow plenum and mixing the portion with the cool heat transfer fluid before it enters the bottom flow plenum.

Example claim 37: A thermal energy storage and power generation system comprising: a closed flow loop comprising in fluid communication a steam turbine-generator assembly, a steam condenser, and a boiler, and a pump operable to circulate boiler feedwater through the closed flow loop; an electric generator operably coupled to the steam turbine and an electric power grid; the boiler comprising: a thermal energy storage vessel containing a thermal mass composition inside; an array of electric heaters embedded in the thermal mass composition, the heaters when energized being operable to heat the thermal mass composition; a tube bundle comprising a plurality of heat exchanger tubes embedded in the thermal mass composition, the heat exchanger tubes configured to convey the boiler feedwater through the heat exchanger tubes; wherein the thermal energy storage vessel is configured to receive the boiler feedwater in a liquid state which is heated by the thermal mass composition therein to generate steam which in turn flows through the closed flow loop to the steam turbine to produce electricity.

Example claim 38: The system according to example 37, wherein the thermal mass composition comprises a mixture of a metallic material and a phase change material each in the form of solid particles before the heaters are energized.

Example claim 39: The system according to example claim 38, wherein the metallic material has a higher melting temperature than the phase change material such that the metallic material remains as a solid particle when the thermal mass composition is heated by the heaters.

Example claim 40: The system according to example claim 38 or 39, wherein the phase change material is meltable when the thermal mass composition is heated by the heaters, the melted phase change material being flowable into interstitial spaces between the solid particles of the metallic material.

Example claim 41: The system according to any one of example claims 38-40, wherein the phase change material is a salt.

Example claim 42: The system according to example claim 37, wherein the heater is an electric immersible heater electrically coupled to an electric power supply.

Example claim 43: The system according to example claim 37, wherein the heater is an immersible heat exchanger which flows a heat transfer fluid through tubes of the immersible heat exchanger embedded in the thermal mass composition.

Example claim 44: A green boiler comprising: a thermal energy storage vessel defining an internal space containing a thermal mass composition operable to store thermal energy; at least one heater embedded in the thermal mass composition, the heater configured to heat the thermal mass composition; a plurality of heat exchangers each comprising a tube bundle including a plurality of heat exchanger tubes embedded in the thermal mass composition, the heat exchanger tubes configured to convey a heat transfer fluid through the thermal mass composition which heats the heat transfer fluid; wherein the plurality of heat exchangers are independently operable of one another.

Example claim 45: The green boiler according to example claim 44, wherein each heat exchanger includes a fluid outlet under control of an associated fluid outlet valve, and a fluid inlet under control of an associated return fluid inlet valve, each fluid outlet valve and return fluid inlet valve being selectively openable and closeable to fluidly couple or fluidly isolate respectively one heat exchanger from the other heat exchangers.

Example claim 46: The green boiler according to example claim 45, further comprising a discharge piping network fluidly coupled to each fluid outlet valve and configured to combine heated heat transfer fluid discharged from each heat exchanger into a single stream, and an inlet piping network fluidly coupled to each return fluid inlet valve and configured to divide incoming cool heat transfer fluid to each heat exchanger.

Example claim 47: The green boiler according to example claim 44, wherein the heated heat transfer fluid discharged from each heat exchanger is steam, and the discharge piping network is fluidly coupled to a steam reservoir configured to store the steam.

Example claim 48: The green boiler according to example claim 46, wherein the discharge piping network comprises a piping manifold configured to receive and combine the heated heater fluid from each heat exchanger.

Example claim 49: The green boiler according to example claim 45, wherein each fluid outlet valve is independently coupled via fluid outlet piping directly to the steam reservoir.

Example claim 50: The green boiler according to any one of example claims 44-49, wherein each heat exchanger includes a top header fluidly coupled to the tubes of a respective tube bundle, and a bottom header fluidly coupled to the tubes of the respective tube bundle, the top and bottom headers of each heat exchanger being fluidly isolated from the top and bottom headers of the other heat exchangers.

Example 51: The green boiler according to example claim 50, wherein the tubes of each tube bundle extend vertically between the top and bottom headers of each respective heat exchanger.

Example 52: The green boiler according to example claim 44, wherein one heat exchanger is disposed in each of four quadrants of the thermal energy storage vessel forming four fluid heating zones.

Example claim 53: A method for operating a green boiler for heating a heat transfer fluid via thermal energy storage comprising: providing a thermal energy storage vessel containing a thermal mass composition operable to store thermal energy; providing a plurality of heat exchangers each comprising a tube bundle including a plurality of heat exchanger tubes embedded in the thermal mass composition, each heat exchanger including a fluid inlet valve and a fluid outlet valve each fluidly coupled to the tube bundle; heating the thermal mass composition; selectively activating one or more of the plurality of heat exchangers thereby allowing a heat transfer fluid to flow through the tube bundles of the activated heat exchangers, the heat transfer fluid becoming heated by extracting heat from the thermal mass composition; and discharging the heated heat transfer fluid from the activated heat exchangers.

Example claim 54: The method according to example claim 53, further comprising combining separate discharge streams of the heated heat transfer fluid from each heat exchanger into a single discharge stream.

Example claim 55: The method according to example claim 54, wherein the separate discharge streams are combined by a piping manifold.

Example claim 56: The method according to example claim 54, wherein the heated heat transfer fluid is steam, and the separate discharge streams are combined by a steam reservoir.

Example claim 57: A green boiler comprising: a thermal energy storage vessel defining an internal cavity containing a thermal mass composition operable to store thermal energy; at least one heater embedded in the thermal mass composition, the at least one heater being configured to heat the thermal mass composition; and at least one heat exchanger. The heat exchanger comprising: a tube bundle including a plurality of heat exchanger tubes embedded in the thermal mass composition, the heat exchanger tubes configured to convey a heat transfer fluid through the thermal mass composition which heats the heat transfer fluid; a top header configured to receive the heated heat transfer fluid from the tube bundle; a bottom header configured to receive and distribute incoming cool heat transfer fluid to the tubes of the tube bundle; and a downcomer fluidly coupled to each of the top and bottom headers. The heat exchanger tubes, the top header, the downcomer, and the bottom header form a circulation loop; wherein the at least one heat exchanger is configured to facilitate flow of the heat transfer fluid through the circulation loop via a thermo-siphon effect.

Example claim 58: The green boiler according to claim 57, wherein the tubes are vertically oriented and extend in a straight path between the top header and the bottom header.

Example claim 59: The green boiler according to claim 58, wherein the downcomer extends vertically from the top header to the bottom header, and the downcomer is located outside the thermal mass composition.

Example claim 60: The green boiler according to any one of claims 57-59, wherein the top and bottom headers are located outside the thermal mass composition.

Example claim 61: The green boiler according to any one of claims 57-60, wherein the heated heat transfer fluid is steam and the top header includes a demister configured to condense excess moisture in the steam which collects in the top header and flows through the downcomer back to the bottom header.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

1. A green boiler comprising:
a thermal energy storage vessel defining an internal space containing a thermal mass composition operable to store thermal energy, the thermal mass composition comprising a metallic material and a phase change material;
at least one heater embedded in the thermal mass composition, the at least one heater configured and operable to heat the thermal mass composition; and
at least one heat exchanger comprising a tube bundle including a plurality of heat exchanger tubes embedded in the thermal mass composition, the heat exchanger tubes configured to convey a heat transfer fluid through the thermal mass composition which heats the heat transfer fluid.

2. The boiler according to claim 1, wherein the thermal energy storage vessel and heat exchanger are physically integrated into a single self-supporting housing.

3. The boiler according to claim 2, wherein the housing comprises a top closure plate, a bottom closure plate, and a plurality of sidewalls extending therebetween.

4. The boiler according to claim 2, wherein the housing comprises a support base configured for placement on a flat concrete foundation slab.

5. The boiler according to claim 2, wherein the housing is vertically elongated and has a rectangular cuboid configuration.

6. The boiler according to claim 3, wherein the heat exchanger comprises a top header supported on the top closure plate and defining a top flow plenum, and a bottom header supported on the bottom closure plate and defining a bottom flow plenum, the top and bottom flow plenums being in fluid communication with the heat exchanger tubes inside the housing.

7. The boiler according to claim 6, wherein the heat exchanger further comprises a top tubesheet supported on the top closure plate inside the top flow plenum, and a bottom tubesheet supported on the bottom closure plate inside the bottom flow plenum.

8. The boiler according to claim 7, wherein top ends of the tubes are coupled to and extend through the top tubesheet, and bottom ends of the heat exchanger tubes are coupled to and extend through the bottom tubesheet.

9. The boiler according to claim 8, wherein the top tubesheet further comprises a plurality of upwardly protruding extension tubes, each extension tube being fluidly coupled to and associated with a respective one of the heat exchanger tubes.

10. The boiler according to claim 9, wherein top ends of the extension tubes terminate at an elevation greater than a surface level of a condensate pool P formed in the top flow plenum inside the top header.

11. The boiler according to claim 8, wherein the housing further comprises an annular thermal expansion sleeve fixedly coupled to the top closure plate, the sleeve circumferentially surrounding the top sheet and a lower portion of top header which are slideably disposed inside the sleeve.

12. The boiler according to claim 11, wherein when the heat exchanger tubes are heated and expand in length, the top sheet and top header move upwards with the top ends of the heat exchanger tubes relative to the top closure plate which remains stationary.

13. The boiler according to claim 6, wherein the top flow plenum is fluidly coupled to the bottom flow plenum by a vertical downcomer located outside the housing.

14. The boiler according to claim 13, wherein the heat transfer fluid recirculates between the top flow plenum and the bottom flow plenum via the downcomer through a passive convective thermo-siphon effect without the assistance of a pump.

15. The boiler according to claim 3, wherein the at least one heater comprises a plurality of heaters each comprising horizontally elongated electric heating elements which extend into the thermal mass composition in the vessel.

16. The boiler according to claim 15, wherein the heaters are removably coupled to an opposing pair of the sidewalls of the housing, the heaters being slideably insertable into and retractable from the internal cavity of the vessel in a horizontal direction.

17. The boiler according to claim 1, wherein the heat transfer fluid comprises water.

18. The boiler according to claim 17, wherein the vessel is configured to convert the water from a liquid state entering the vessel to steam exiting the vessel.

19. The boiler according to claim 17, wherein the vessel is configured to receive the water in a liquid state at a first temperature and discharge the water in a liquid state at a second temperature higher than the first temperature.

20. The boiler according to claim 1, wherein the thermal mass composition comprises a mixture of a metallic material and a phase change material each in the form of solid particles at ambient temperature.

21. The boiler according to claim 20, wherein the metallic material has a higher melting temperature than the phase change material.

22. The boiler according to claim 3, wherein the at least one heater comprises heat exchanger tubes which extend into the thermal mass composition in the vessel, the heat exchanger tubes flowing a heated second heat transfer fluid through the tubes which heats the thermal mass composition.

23. The boiler according to claim 22, wherein the heaters are removably coupled to an opposing pair of the sidewalls of the housing, the heaters being slideably insertable into and retractable from the internal cavity of the vessel in a horizontal direction.

24-61. (canceled)
